(19) United States
(12) Patent Application Publication
(10) Pub. No.: US 2026/0046822 A1
(43) Pub. Date: Feb. 12, 2026

(54) SIDELINK-BASED POSITIONING METHOD AND APPARATUS

(71) Applicant: Samsung Electronics Co., Ltd., Gyeonggi-do (KR)

(72) Inventors: Miao ZHOU, Beijing (CN); Min WU, Beijing (CN); Feifei SUN, Beijing (CN); Qi XIONG, Beijing (CN)

(21) Appl. No.: 19/102,517

(22) PCT Filed: Aug. 7, 2023
(86) PCT No.: PCT/KR2023/011601

§ 371 Date: Feb. 10, 2025

(30) Foreign Application Priority Data
Aug. 10, 2022 (CN) 202210956796.2

(51) Int. Cl. H04W 64/00; H04W 72/25

(52) U.S. Cl. CPC H04W 64/00; H04W 72/25

(57) ABSTRACT

The disclosure relates to a 5G or 6G communication system for supporting a higher data transmission rate. The present disclosure discloses a method and a device in a wireless communication system. This document provides a method performed by a first user terminal UE in a wireless communication system, comprising: acquiring by the first UE a configuration related to a Sidelink Positioning Reference Signal (SL PRS); and transmitting by the first UE the SL PRS and Sidelink Control Information (SCI) associated with the SL PRS to a second UE based on the configuration related to the SL PRS; wherein a resource used to transmit the SL PRS is determined based on the configuration related to the SL PRS, and/or a resource correspondence between SL PRS resources and PSCCH, and a determined PSCCH resource; and/or wherein a PSCCH resource used to transmit the SCI is determined based on a related configuration of a PSCCH associated with the SL PRS, and/or the resource correspondence between the SL PRS and the PSCCH, and a determined resource used to transmit the SL PRS.

### TECHNICAL FIELD

The present application relates to the field of wireless communication technology, and more specifically, to a positioning method and device based on sidelink (SL) communication in a wireless system in the fifth-generation new radio access technology (5G NR) system.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present disclosure relates to wireless communication systems and, more specifically, the present disclosure relates to a sidelink-based positioning.

### Solution to Problem

According to an aspect of the present disclosure, there is provided a method performed by a first user equipment UE in a wireless communication system, comprising: acquiring by the first UE a configuration related to a Sidelink Positioning Reference Signal (SL PRS); and transmitting by the first UE the SL PRS and Sidelink Control Information (SCI) associated with the SL PRS to a second UE based on the configuration related to the SL PRS; wherein a resource used to transmit the SL PRS is determined based on the configuration related to the SL PRS, and/or a correspondence between SL PRS resources and PSCCH resources, and a determined PSCCH resource; and/or wherein a PSCCH resource used to transmit the SCI is determined based on a related configuration of a PSCCH associated with the SL PRS, and/or the correspondence between the SL PRS resources and the PSCCH resources, and a determined resource used to transmit the SL PRS.

In various embodiments, wherein the first UE determines whether SL PRSs using different SL PRS resources can be multiplexed on a same time-domain and/or frequency-domain resource based on the configuration; and/or the first UE determines, based on the configuration, SL PRSs, which can be multiplexed on the same time-domain and/or frequency-domain resource, of the SL PRSs using the different SL PRS resources.

In various embodiments, the first UE determines that two or more SL PRSs using the different SL PRS resources are multiplexed on the same time-domain and/or frequency-domain resource when at least one of the following conditions is met: starting positions of time-domain and/or frequency-domain resources of the two or more SL PRSs are the same, ending positions of the time-domain and/or frequency-domain resources of the two or more SL PRSs are the same, sizes of the time-domain and/or frequency-domain resources of the two or more SL PRSs are the same, the time-domain and/or frequency-domain resources of the two or more SL PRSs are the same, the time-domain and/or frequency-domain resources of the two or more SL PRSs are in a same slot, the frequency-domain resources of the two or more SL PRSs are in a same Resource Block (RB), the frequency-domain resources of the two or more SL PRSs are in a same subchannel, and the frequency-domain resources of the two or more SL PRSs are in a same subchannel group.

In various embodiments, the configuration related to the SL PRS comprises a related configuration of a subchannel group used to transmit the SL PRS and/or a related configuration of Physical Sidelink Control Channels (PSCCHs) associated with the SL PRS.

In various embodiments, the related configuration of the subchannel group used to transmit the SL PRS comprises at least one of the following: information as to whether to enable the subchannel group; a size of the subchannel group; indexes of subchannels included in the subchannel group; and a frequency-domain resource position of at least one subchannel group.

In various embodiments, the related configuration of the PSCCH associated with the SL PRS comprises at least one of the following: positions of PSCCH resources included in a subchannel; positions of PSCCH resources included in a subchannel group; a number of PSCCH occasions included in the subchannel; a number of PSCCH occasions included in the subchannel group; a time-domain resource size and/or frequency-domain resource size of one or each of PSCCH occasions; a time-domain resource position and/or frequency-domain resource position of a starting PSCCH occasion included in the subchannel; time-domain resource position and/or frequency-domain resource positions of a starting PSCCH occasion included in the subchannel group; and an offset between two adjacent or any two PSCCH occasions, wherein, the PSCCH occasions comprise a resource unit used to transmit at least one PSCCH.

In various embodiments, the number of PSCCH occasion(s) included in a subchannel is one or more, and when the subchannel comprises a plurality of PSCCH occasions, the plurality of PSCCH occasions correspond to transmission of SCI associated with a plurality of SL PRSs multiplexed on the subchannel; and/or the number of PSCCH occasion(s) included in the subchannel group is one or more, and when the subchannel group comprises a plurality of PSCCH occasions, the plurality of PSCCH occasions correspond to transmission of SCI associated with a plurality of SL PRSs multiplexed on the subchannel group.

In various embodiments, when a subchannel comprises one or more PSCCH occasions, a time-domain and/or frequency-domain resource occupied by a PSCCH occasion with the lowest Physical Resource Block (PRB) index is the same as a time-domain and/or frequency-domain resource of a PSCCH in a sidelink communication system; and/or when at least one subchannel in the subchannel group comprises a PSCCH occasion, a time-frequency-domain resource occupied by the PSCCH occasion is the same as a PSCCH resource in the sidelink communication system.

In various embodiments, when the subchannel comprises one or more PSCCH occasions and a resource pool for PSCCHs and SL PRSs is configured to be shared with sidelink communication, a time-domain and/or frequency-domain resource occupied by a PSCCH occasion with the lowest index of Physical Resource Block (PRB) is the same as a time-domain and/or frequency-domain resource of a PSCCH in the sidelink communication system; and/or when at least one subchannel in the subchannel group comprises a PSCCH occasion and a resource pool for PSCCHs and SL PRSs is configured to be shared with sidelink communication, a time-frequency-domain resource occupied by the PSCCH occasion is the same as a PSCCH resource in the sidelink communication system.

In various embodiments, when the first UE transmits an SL PRS in at least one subchannel group, and a resource pool for PSCCHs and SL PRSs is configured to be shared with sidelink communication, a time-domain and/or frequency-domain resource used by the SL PRS is indicated in SCI based on subchannels; and/or when the first UE transmits an SL PRS in at least one subchannel group, and a resource pool for PSCCHs and SL PRSs is configured to be dedicated to SL PRSs, a time-domain and/or frequency-domain resource used by the SL PRS is indicated in SCI based on subchannels or the subchannel group.

In various embodiments, a preset correspondence between SL PRS resources and PSCCH resources comprises a correspondence between resources used to transmit the SL PRS and PSCCH occasions; and/or the correspondence between the SL PRS resources and the PSCCH resources comprises a correspondence between a set of SL PRS resources and PSCCH occasions.

In various embodiments, the correspondence between the set of SL PRS resources and the PSCCH occasions comprises a mapping relationship between indexes of the SL PRS resources and indexes of the PSCCH occasions, and the method for indexing the PSCCH occasions comprises at least one of the following: obtaining the indexes of the PSCCH occasions by ordering the PSCCH occasions in ascending order in the frequency domain in the subchannels; in the subchannel group, the subchannels are first ordered in the frequency domain in ascending order, and obtaining the indexes of the PSCCH occasions by ordering the PSCCH occasions in a manner of ascending order in the frequency domain in the subchannel group first and then ascending order of PRBs in the subchannels.

In various embodiments, the related configuration of the PSCCH associated with the SL PRS comprises at least one of the following: a PSCCH period, which indicates a number of time units corresponding to a period of PSCCH resources in the resource pool; all PSCCH frequency-domain resources in the resource pool; a frequency-domain resource of a PSCCH resource; and an index of a PSCCH resource.

In various embodiments, the correspondence between the SL PRS resources and the PSCCH resources comprises: when the first UE transmits the SL PRS in slot n, a PSCCH associated with the SL PRS being transmitted in a latest slot containing a PSCCH resource no later than slot n-k.

In various embodiments, the correspondence between the SL PRS resources and the PSCCH resources comprises: for SL PRS resources within a PSCCH period, PSCCH resources being allocated to each of the SL PRS resources sequentially in ascending order of PSCCH resources indexes, in a manner of ascending order in time domain first and then ascending order in frequency domain and then ascending order of SL PRS resource indexes, or in a manner of ascending order in frequency domain first and then ascending order in time domain and then ascending order of SL PRS resource indexes.

In various embodiments, if SL PRS resources selected by the first UE comprise a plurality of subchannels, the first UE acquires a corresponding PSCCH resource according to a subchannel with the lowest index of the plurality of subchannels according to a correspondence between the resources; and/or maps and acquires the corresponding PSCCH resource according to all of the subchannels according to the correspondence between the resources.

In various embodiments, when the first UE acquires a plurality of PSCCH resources for transmitting SCI, the first UE transmits SCI corresponding to the SL PRS to the second UE on the plurality of PSCCH resources or transmits the SCI corresponding to the SL PRS to the second UE on a subset of the plurality of PSCCH resources.

In various embodiments, when there are PSCCH resources and Physical Sidelink Shared Channel (PSSCH) resources in the resource pool, the PSCCH resource corresponding to the PSCCH resource used by the first UE to transmit the SCI is used for at least one of the following: transmitting the SL PRS; transmitting the PSSCH; and not being used for transmitting the SL PRS or the PSSCH.

In various embodiments, the method for the first UE to transmit the PSSCH and the SL PRS to the second UE and indicate the control information of the SL PRS and/or the control information of the PSSCH in the PSCCH resource comprises at least one of the following: transmitting a SCI format associated with the SL PRS and a SCI format associated with the PSSCH on the PSCCH resource; transmitting the SCI format associated with the SL PRS on the PSCCH resource, and further indicating a resource used by the PSSCH in the SCI format; transmitting the SCI format associated with the PSSCH on the PSCCH resource, and further indicating a resource used by the SL PRS in the SCI format; transmitting the SCI format associated with the SL PRS on the PSCCH resource, and transmitting the SCI format associated with the PSSCH on the PSSCH resource corresponding to the PSCCH resource; and transmitting the SCI format associated with the PSSCH on the PSCCH resource, and transmitting the SCI format associated with the SL PRS on the PSSCH resource corresponding to the PSCCH resource.

According to one aspect of the present disclosure, there is provided a method performed by a second UE in a wireless communication system, the comprising: receiving by a second UE a Sidelink Positioning Reference Signal (SL PRS) and Sidelink Control Information (SCI) associated with the SL PRS from a first UE; and performing measurement by the second UE based on the received SL PRS and the Sidelink Control Information (SCI) associated with the SL PRS.

In a further embodiment, the second UE receives the SCI and the SL PRS on the resource on which the first UE transmitted the SCI and the SL PRS as described above.

In various embodiments, the second UE receives the SCI corresponding to the SL PRS from the first UE on the plurality of PSCCH resources or receives the SCI corresponding to the SL PRS on a subset of the plurality of PSCCH resources.

In various embodiments, when there are PSCCH resources and Physical Sidelink Shared Channel PSSCH resources in the resource pool, the PSCCH resource corresponding to the PSCCH resource used by the second UE to receive the SCI is used for at least one of the following: receiving the SL PRS; receiving the PSSCH; and not being used for receiving the SL PRS or the PSSCH.

In various embodiments, the method for the second UE to receive the PSSCH and the SL PRS from the first UE and receive the control information of the SL PRS and/or the control information of the PSSCH in the PSCCH resource comprises at least one of the following: receiving a SCI format associated with the SL PRS and a SCI format associated with the PSSCH on the PSCCH resource; receiving the SCI format associated with the SL PRS on the PSCCH resource, and further indicating a resource used by the PSSCH in the SCI format; receiving the SCI format associated with the PSSCH on the PSCCH resource, and further indicating a resource used by the SL PRS in the SCI format; receiving the SCI format associated with the SL PRS on the PSCCH resource, and receiving the SCI format associated with the PSSCH on the PSSCH resource corresponding to the PSCCH resource; and receiving the SCI format associated with the PSSCH on the PSCCH resource, and receiving the SCI format associated with the SL PRS on the PSSCH resource corresponding to the PSCCH resource.

According to one aspect of the present disclosure, there is provided a user equipment (UE) in a wireless communication system, comprising: a transceiver configured to transmit and receive a signal; and a processor coupled to the transceiver and configured to control the transceiver to perform the method as described above.

### Advantageous Effects of Invention

According to an embodiment of the disclosure, a wireless communication can be performed efficiently.

### BRIEF DESCRIPTION OF DRAWINGS

FIG. 1 is an overall structure of a wireless network;

FIG. 2a illustrates a transmission path and reception path;

FIG. 2b illustrates a transmission path and reception path;

FIG. 3a is a structure diagrams of a UE and a base station;

FIG. 3b is a structure diagrams of a UE and a base station;

FIG. 4 illustrates an example in which a sidelink channel occupies one slot and all resource elements on a subchannel;

FIG. 5 illustrates two examples in which one SL PRS resource occupies a slot and a portion of REs on a subchannel/RB according to an embodiment of the present disclosure;

FIG. 6 illustrates an example in which a plurality of SL PRSs using non-overlapping resources are multiplexed on a same slot and a same frequency-domain resource with a length of N subchannels according to an embodiment of the present disclosure;

FIG. 7 illustrates an example of determining a PSCCH occasion according to an embodiment of the present disclosure;

FIG. 8 illustrates another example of determining a PSCCH occasion according to an embodiment of the present disclosure;

FIG. 9 illustrates a diagram of a mapping relationship between SL PRSs in a plurality of slots and multiplexed on same time-frequency resources and PSCCH resources corresponding thereto, provided by taking a subchannel as an example, according to an embodiment of the present disclosure;

FIG. 10 illustrates a diagram in which a first UE transmits an SL PRS and control information of the SL PRS to a second UE and indicates a resource of the SL PRS in the control information according to an embodiment of the present disclosure.

FIG. 11 illustrates an exemplary method according to an embodiment of the disclosure.

### MODE FOR THE INVENTION

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are devised to be implemented in higher frequency bands, e.g., 28 GHz millimeter wave (mmWave) bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The following description with reference to the accompanying drawings is provided to facilitate a comprehensive understanding of various embodiments of the present disclosure as defined by the claims and their equivalents. This description comprises various specific details to facilitate understanding but should be regarded as exemplary only. Accordingly, those of ordinary skill in the art will recognize that various changes and modifications of the various embodiments described herein can be made without departing from the scope and spirit of the present disclosure. Also, descriptions of well-known functions and constructions may be omitted for clarity and conciseness.

The terms and phraseology used in the following specification and claims are not limited to their dictionary meanings, but, are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the scope of the present disclosure as defined by the appended claims and their equivalents.

It should be understood that the singular forms “a”, “an” and “the” comprise plural referents unless the context clearly dictates otherwise. Thus, for example, reference to “a component surface” comprises reference to one or more of such surfaces.

The terms “comprise” or “may comprise” refer to presence of a correspondingly disclosed function, operation, or component that may be used in various embodiments of the present disclosure, rather than excluding presence of one or more additional functions, operations, or features. Furthermore, the terms “comprise” or “have” may be interpreted to mean certain characteristics, numbers, steps, operations, constituent elements, components, or combinations thereof, but should not be interpreted as excluding one or more other characteristics, numbers, steps, operations, constituent elements, components, or the possibility of existence of a combination thereof.

The term “or” as used in various embodiments of the present disclosure comprises any of the listed terms and all combinations thereof. For example, “A or B” may comprise A, may comprise B, or may comprise both A and B.

Unless defined differently, all terms (including technical or scientific terms) used in this disclosure have the same meaning as understood by one of ordinary skill in the art described in this disclosure. Common terms as defined in dictionaries are to be interpreted to have meanings consistent with the context in the relevant technical field, and should not be interpreted ideally or overly formalized unless explicitly so defined in this disclosure.

In order to make the objectives, solutions and advantages of the embodiments of the present disclosure more clear, the solutions of the embodiments of the present disclosure will be clearly and completely described below with reference to the accompanying drawings of the embodiments of the present disclosure. Obviously, the described embodiments are some, but not all, of the embodiments of the present disclosure. Based on the described embodiments of the present disclosure, all other embodiments obtained by persons skilled in the art without creative efforts shall fall within the scope of the present disclosure. The text and accompanying drawings are provided only as examples to assist readers in understanding this disclosure. They are not intended and should not be interpreted as limiting the scope of this disclosure in any way. Although certain embodiments and examples have been provided, based on the content disclosed herein, it is apparent to those skilled in the art that changes can be made to the illustrated embodiments and examples without departing from the scope of the present disclosure.

Before undertaking the detailed description below, it may be advantageous to set forth definitions of certain words and phrases used throughout this patent document. The term “couple” and its derivatives mean any direct or indirect communication between two or more elements, whether or not those elements are in physical contact with each other. The terms “transmit”, “receive” and “communicate” and their derivatives encompass both direct and indirect communications. The terms “include” and “comprise,” as well as derivatives thereof, mean inclusion without limitation. The term “or,” is inclusive, meaning and/or. The phrase “associated with” and derivatives thereof, mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system or part thereof that controls at least one operation. Such a device may be implemented in hardware, firmware or software, or some combination of at least two of the same. The functionality associated with any particular controller may be centralized or distributed, whether locally or remotely. The phrase “at least one of” when used with a list of items means that different combinations of one or more of the listed items may be used, and that only one item of the list may be required. For example, “at least one of A, B, and C” comprises any of the following combinations: A, B, C, A and B, A and C, B and C, and A and B and C. For example, “at least one of A, B, or C” comprises any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” comprises any type of computer code, including source code, object code, and executable code. The phrase “computer readable medium” comprises any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium comprises media where data can be permanently stored and media where data can be stored and later overwritten, such as a rewritable optical disc or an erasable memory device.

The terminology used herein to describe embodiments of the invention is not intended to limit and/or define the scope of the invention. For example, unless otherwise defined, technical or scientific terms used in this disclosure should be given the ordinary meaning as understood by one of ordinary skill in the art to which this invention belongs.

It should be understood that use of “first,” “second,” and similar terms in this disclosure do not denote any order, quantity, or importance, but are merely used to distinguish the various components. Unless the context clearly dictates otherwise, the singular forms “a,” “an,” or “the” and similar words do not denote a limitation of quantity, but rather denote the presence of at least one.

As used herein, any reference to “one example” or “example”, “one embodiment” or “an embodiment” means that a particular element, feature, structure or characteristic described in connection with the embodiment is included in at least one in the examples. The appearances of the phrases “in one embodiment” or “in one example” in various places in the specification are not necessarily all referring to the same embodiment.

As used herein, “a portion” of something means “at least some” of that thing, and thus may mean less than all or all of that thing. Thus, “a part” of a thing comprises the whole thing as a special case, i.e., instances where the whole thing is a part of the thing.

As used herein, the term “a set” means one or more. Thus, a set of items may be a single item or a set of two or more items.

In the present disclosure, in order to determine whether a certain condition is met expressions such as “greater than” or “less than” are used as examples, and expressions such as “greater than or equal to” or “less than or equal to” are also applicable, and are not excluded. For example, a condition defined with “greater than or equal to” may be replaced with “greater than” (or vice versa), and a condition defined with “less than or equal to” may be replaced with “less than” (or vice versa), and so on.

It will be further understood that the terms “comprise” or “include” and similar words mean that the elements or things appearing before the word encompass the elements or things listed after the word and their equivalents, but do not exclude other elements or things. Words like “connected” or “connected” are not limited to physical or mechanical connections, but may comprise electrical connections, whether direct or indirect. “Up”, “Down”, “Left”, “Right”, etc. are only used to represent the relative positional relationship, and when the absolute position of the described object changes, the relative positional relationship may also change accordingly.

The various embodiments discussed below to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. For example, although the following detailed description of embodiments of the present disclosure will be directed to LTE and 5G communication systems, those skilled in the art will appreciate that the main points of the present disclosure may be modified slightly without substantially departing from the scope of the present disclosure. It can be applied to other communication systems with similar technical background and channel format.

The following description with reference to the accompanying drawings is provided to facilitate a comprehensive understanding of various embodiments of the present disclosure as defined by the claims and their equivalents. This description comprises various specific details to facilitate understanding but should be regarded as exemplary only. Accordingly, those of ordinary skill in the art will recognize that various changes and modifications of the various embodiments described herein can be made without departing from the scope and spirit of the present disclosure. Also, descriptions of well-known functions and constructions may be omitted for clarity and conciseness.

The terms and phraseology used in the following specification and claims are not limited to their dictionary meanings, but, are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the scope of the present disclosure as defined by the appended claims and their equivalents.

It should be understood that the singular forms “a”, “an” and “the” comprise plural referents unless the context clearly dictates otherwise. Thus, for example, reference to “a component surface” comprises reference to one or more of such surfaces.

The terms “comprise” or “may comprise” refer to presence of a correspondingly disclosed function, operation, or component that may be used in various embodiments of the present disclosure, rather than excluding presence of one or more additional functions, operations, or features. Furthermore, the terms “comprise” or “have” may be interpreted to mean certain characteristics, numbers, steps, operations, constituent elements, components, or combinations thereof, but should not be interpreted as excluding one or more other characteristics, numbers, steps, operations, constituent elements, components, or the possibility of existence of a combination thereof.

The term “or” as used in various embodiments of the present disclosure comprises any of the listed terms and all combinations thereof. For example, “A or B” may comprise A, may comprise B, or may comprise both A and B.

Unless defined differently, all terms (including technical or scientific terms) used in this disclosure have the same meaning as understood by one of ordinary skill in the art described in this disclosure. Common terms as defined in dictionaries are to be interpreted to have meanings consistent with the context in the relevant technical field, and should not be interpreted ideally or overly formalized unless explicitly so defined in this disclosure.

The solutions of the embodiments of the present application may be applied to various communication systems. For example, the communication systems may comprise a Global System for Mobile communications (GSM) system, a code division multiple access (CDMA) system, a broadband Code Division Multiple Access (WCDMA) system, General Packet Radio Service (GPRS), Long Term Evolution (LTE) system, LTE Frequency Division Duplex (FDD) system, LTE Time Division Duplex (TDD), universal mobile telecommunication system (UMTS), worldwide interoperability for microwave access (WiMAX) communication system, fifth generation (5th generation, 5G) system or new radio (NR), etc. In addition, the solutions of the embodiments of the present application may be applied to future-oriented communication technologies. In addition, the solutions of the embodiments of the present application may be applied to future-oriented communication technologies.

Hereinafter, embodiments of the present disclosure will be described in detail with reference to the accompanying drawings. It should be noted that the same reference numerals will be used in different drawings to refer to the same elements that have been described.

Aiming at the communication problem in the wireless cellular communication scenario, the present disclosure proposes a scheme to improve the communication performance in this scenario through the interaction information between the network-side entity and the user equipment.

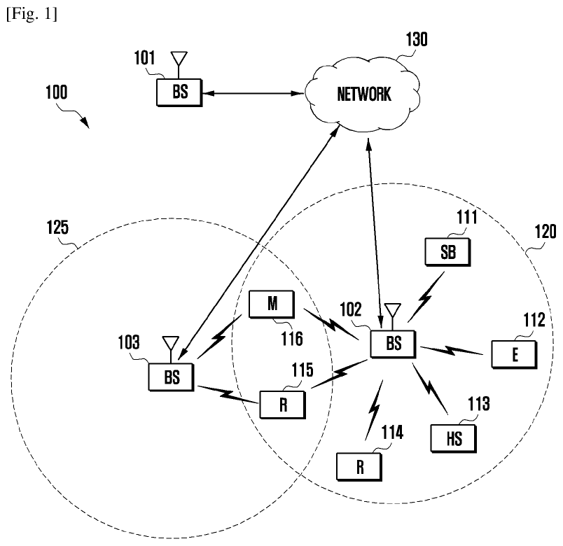

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 comprises a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs comprise a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs comprise a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 comprise a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can comprise any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

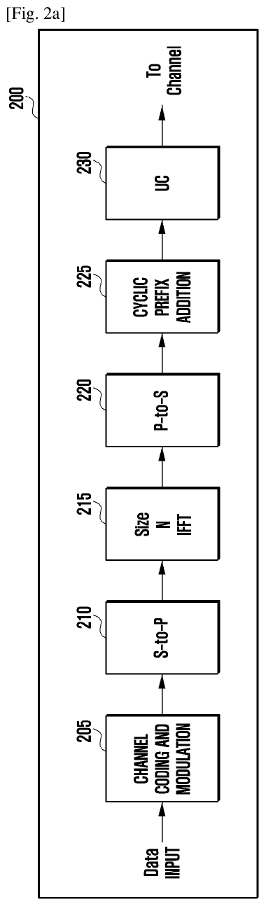

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 comprises a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 comprises a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

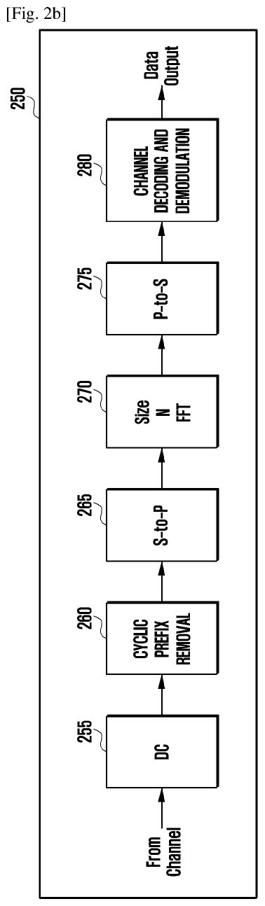

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 comprises an antenna 305, a radio frequency (RF) transceiver 310, a transmission (TX) processing circuit 315, a microphone 320, and a reception (RX) processing circuit 325. UE 116 also comprises a speaker 330, a processor/controller 340, an input/output (I/O) interface 345, an input device(s) 350, a display 355, and a memory 360. The memory 360 comprises an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can comprise one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 comprises at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can comprise a random access memory (RAM), while another part of the memory 360 can comprise a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can comprise the same or similar structures as gNB 102.

As shown in FIG. 3b, gNB 102 comprises a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n comprise a 2D antenna array. gNB 102 also comprises a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can comprise one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 comprises at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 comprises any suitable structure that supports communication through a wired or wireless connection, such as an Ethernet or an RF transceiver.

The memory 380 is coupled to the controller/processor 378. A part of the memory 380 can comprise an RAM, while another part of the memory 380 can comprise a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can comprise any number of each component shown in FIG. 3a. As a specific example, the access point can comprise many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 may comprise multiple instances of each (such as one for each RF transceiver).

As an evolution technology of LTE, a 5G NR system also resultantly comprises further evolution of sidelink communication. NR V2X technology was formulated in Release 16. As an evolution version of LTE V2X technology, NR V2X has better performance in all aspects. In Release 17, a 5G NR system is expected to further expand the application scenarios of NR V2X to other broader application scenarios, such as commercial sidelink communication and Public Safety (PS) scenarios. In Release 18, 5G NR SL will further introduce evolution corresponding to other scenarios and applications, such as SL technology on high frequencies (FR2) and unlicensed frequency bands, and SL technology corresponding to specific applications such as positioning.

In a traditional wireless communication system, the positioning technology is achieved mainly based on a UE receiving from or transmitting to a base station a signal/channel for positioning. Therefore, the positioning functionality of the UE depends on the distribution of base stations and network coverage, and the cost requirement for network deployment is relatively high. For example, the positioning precision of the UE is poor when the network deployment is relatively sparse, and it is difficult to realize the positioning functionality when the UE is outside the coverage of a cell. Therefore, the introduction of sidelink communication-based positioning technology could effectively improve applicable scenarios of positioning technology and improve the positioning precision in most scenarios.

The sidelink communication-based positioning technology needs to be implemented based on the UE receiving from or transmitting to another UE a signal/channel for positioning. The receiving/transmitting mainly occurs on sidelink channels instead of uplink/downlink channels in traditional positioning technologies. Similar to the uplink/downlink positioning technologies, the UE needs to transmit/receive a Sidelink Positioning Reference Signal (SL PRS) to/from another UE in the sidelink positioning technology. Compared with traditional sidelink communication, there are differences in channel structure between an SL PRS and a Physical Sidelink Shared Channel in traditional sidelink communication, resulting in the necessity to adjust the design of the channel structure of the SL PRS. In addition, the channel structure of the PSSCH associated with the SL PRS also needs to be adjusted accordingly to adapt to the channel structure of the SL PRS, so as to achieve reasonable mapping relationship between the Physical Sidelink Control Channel (PSCCH) and the SL PRS, thereby achieving effects of improving channel utilization efficiency and reducing conflict probability in the system.

The present invention provides a method for enabling each slot and subchannel to accommodate a plurality of SL PRSs and enabling PSCCHs corresponding thereto to use mutually orthogonal resource positions in sidelink communication-based positioning. The method increases the capacity of the SL PRSs, and decreases potential conflicts between the PSCCHs associated with the SL PRSs, thereby improving the utilization efficiency of air interface resources and facilitating improvement of the reliability of sidelink positioning.

In the Long Term Evolution (LTE) technology, sidelink communication mainly comprises two types of mechanism, direct communication from Device to Device (D2D) and communication from Vehicle to Everything (Vehicle to Vehicle/Infrastructure/Pedestrian/Network, collectively referred to as V2X), in which V2X is devised on the basis of D2D technology, is superior to D2D in terms of data rate, latency, reliability, link capacity, etc., and is the most representative sidelink communication technology in LTE technology. In a 5G system, sidelink communication currently mainly comprises Vehicle to Everything (V2X) communication.

As an evolution technology of LTE, a 5G NR system also resultantly comprises further evolution of sidelink communication. NR V2X technology was formulated in Release 16. As an evolution version of LTE V2X technology, NR V2X has better performance in all aspects. In Release 17, a 5G NR system is expected to further expand the application scenarios of NR V2X to other broader application scenarios, such as commercial sidelink communication and Public Safety (PS) scenarios. In Release 18, the evolution of sidelink communication comprises support for aspects such as unlicensed frequency bands, FR2, carrier aggregation, and co-channel coexistence with LTE, as well as support for technologies in other fields such as positioning.

In an embodiment of this application, information, configured by a base station, indicated by a signaling, configured by an upper layer, and pre-configured, may comprise a set of configuration information. In another embodiment, the information may also comprise a plurality of sets of configuration information, in which case, a UE selects a set of configuration information therefrom to use according to a predefined condition. In yet another embodiment, the information may also comprise a set of configuration information including a plurality of subsets, in which case, the UE selects a subset therefrom to use according to a predefined condition.

In an embodiment of the present application, being lower than a threshold may also be replaced by being lower than or equal to the threshold, being higher than (exceeding) a threshold may also be replaced by being higher than or equal to the threshold, being less than or equal may also be replaced by being less than, being greater than or equal to may also be replaced with being greater than; and vice versa.

Some technical solutions provided in embodiments of this application are specifically described based on V2X systems, but application scenarios of this application should not be limited to V2X systems in sidelink communication, but may also be applied to other sidelink transmission systems. For example, designs based on V2X subchannel in following embodiments may also be used for D2D subchannels or other subchannels for sidelink transmission. A V2X resource pool in the following embodiments may also be replaced by a D2D resource pool in other sidelink transmission systems (such as a D2D system).

In embodiments of the present application, when the sidelink communication system is a V2X system, terminals or UEs mentioned herein may be various types of terminals or UEs such as vehicles, infrastructures, and pedestrians.

Base stations in this specification may also be replaced by other nodes, such as sidelink nodes. A specific example is a Road Side Unit (RSU) UE in a sidelink system, and the RSU may be an infrastructure UE. Any mechanism applicable to a base station in present embodiments may also be similarly used in a scenario where the base station is replaced by another sidelink node, and the description thereof will not be repeated.

In this specification, a slot may also be replaced by a time unit, a candidate slot may also be replaced by a candidate time unit, and a candidate single-slot resource may also be replaced by a candidate single-time unit resource. The time unit may comprise a specific time length, such as several consecutive symbols.

A slot in this specification may be a subframe or a slot in the physical sense, or a subframe or a slot in the logic sense. Specifically, a subframe or a slot in the logic sense is a subframe or a slot corresponding to a resource pool for sidelink communication. For example, in a V2X system, a resource pool is defined by a repeated bitmap, and the bitmap is mapped to a specific set of slots. The specific set of slots may be all slots, or all other slots except some specific slots (such as slots for transmitting MIBs (Master Information Blocks)/SIB (System Information Blocks)). A slot indicated as “1” in the bitmap can be used for V2X transmission and belongs to slots corresponding to the V2X resource pool; and a slot indicated as “0” cannot be used for V2X transmission and does not belong to the slots corresponding to the V2X resource pool.

The following is a typical application scenario to illustrate differences between subframes or slots in the physical or logic sense: in the case of calculating a time-domain gap between two specific channels/messages (such as PSSCH carrying sidelink data and PSFCH carrying corresponding feedback information), it is assumed the gap is N slots, if a subframe or slot in the physical sense is calculated, the N slots correspond to the absolute time length of N*x milliseconds in time domain, where x is a time length of a physical slot (subframe) under the numerology of this scenario, in milliseconds; otherwise, if a subframe or slot in the logic sense is calculated, taking the sidelink resource pool defined by the bitmap as an example, a gap of the N slots corresponds to N slots indicated as “1” in the bitmap, and the absolute time length of the gap varies with specific configurations of the sidelink communication resource pool, rather than being a fixed value.

Furthermore, a slot in this specification may be a complete slot, or may be several symbols corresponding to sidelink communication in a slot. For example, when the sidelink communication is configured as being performed on X1th˜X2th symbols, a slot in the following embodiments is the X1th˜X2th symbols in a slot in this scenario; or, when the sidelink communication is configured as a mini-slot transmission, a slot in the following embodiments is a mini-slot defined or configured in a sidelink system, rather than a slot in a NR system; or, when the sidelink communication is configured as symbol-level transmission, a slot in the following embodiments may be replaced by a symbol, or may be replaced by N symbols as a time-domain symbol-level granularity of transmission.

In order to make the purpose, solutions and advantages of the present application clearer, implementations of the present application will be further described in detail below in conjunction with the accompanying drawings.

The text and figures are provided as examples only to assist the reader in understanding the present disclosure. They are not intended and should not be construed as limiting the scope of the present disclosure in any way. While certain embodiments and examples have been provided, based on what is disclosed herein it will be apparent to those skilled in the art that variations to the illustrated embodiments and examples may be made without departing from the scope of the present disclosure.

Sidelink communication-based positioning technologies may support UE-based (UE-based) positioning and UE-assisted positioning. The former mainly includes transmitting or receiving a positioning signal by a UE and collecting a measurement results; and based on the collected result, performing positioning at the UE. The latter mainly includes transmitting a positioning signal by a UE, or measuring the positioning signal and reporting a measurement result to the network side, and completing positioning of the UE by the network side. Correspondingly, in the sidelink communication-based positioning technologies, there are several typical scenarios wherein:
A first UE transmits a signal/channel for positioning to a base station and/or another sidelink UE via a sidelink, for measurement by the base station and/or the another sidelink UE; and a measurement result may be reported to the network side or fed back to the first UE, for use in determine position information of the first UE;
A first UE transmits a signal/channel for positioning to a base station and/or another sidelink UE via a sidelink, for measurement by the base station and/or the another sidelink UE; and a measurement result may be reported to the network side or fed back to the first UE, for use in determine position information of the another UE;
A first UE receives and measures a signal/channel for positioning transmitted by a base station and/or another sidelink UE via a sidelink; and a measurement result may be reported to the network side or fed back to the base station and/or the another sidelink UE, for use in determine position information of the first UE; and
A first UE receives and measures a signal/channel for positioning transmitted by a base station and/or another sidelink UE via a sidelink; and a measurement result may be reported to the network side or fed back to the base station and/or the another sidelink UE, for use in determine position information of the another UE. In the following description, actions performed by the first UE are described from the perspective of the first UE. For the sake of redundancy, actions by a second UE are not specifically described, but the second UE cooperates with the first UE to perform actions as the opposite side. In addition, the ordinal numbers in the “first UE” and “second UE” used herein are only used to distinguish two different UEs, and actually, they may be used interchangeably.

In this specification, a method of a UE determining whether to transmit/receive a positioning-related signal/channel via a sidelink, and determining a corresponding sidelink resource and transmitting/receiving the positioning-related signal/channel on the resource is illustrated, in conjunction with the above-mentioned several typical application scenarios.

In this specification, the mentioned nodes may be at least one of the following: a base station, a Location Management Function (LMF), and a sidelink UE.

In this specification, receiving a signal/channel for positioning may also be replaced by measuring the same or by receiving and measuring the same.

In this specification, a time-frequency resource may be a time-domain resource and/or a frequency-domain resource, which will not be described repeatedly here.

This specification provides a design for sidelink positioning reference signal (SL PRS) and a design of a channel structure of an associated physical sidelink control channel (PSCCH) thereof; wherein, an SL PRS refers to a reference signal for positioning transmitted on a sidelink, including but not limited to a PRS, SRS-Pos, positioning reference signal designed for sidelink, and the like; and wherein, the PSCCH is used to cause a sidelink UE to transmit control information of the sidelink PRS on it, and it may also be similarly replaced by other channels with the same purpose, without limiting the protection scope by its names.

In sidelink positioning technologies, resource allocation for sidelink positioning is performed based on a resource pool. Currently, there are mainly two types of resource pools: a resource pool dedicated to an SL PRS and a resource pool shared with sidelink communication. For the resource pool dedicated to an SL PRS, the resource pool is at least used for transmission of an SL PRS, and in a further embodiment, it may also be used for transmission of a PSCCH associated with the SL PRS and/or a measurement report of the SL PRS. For the resource pool shared with sidelink communication, the resource pool is used for transmission of a signal/channel related to sidelink positioning, the transmission of the signal/channel related to sidelink positioning comprising at least transmission of an SL PRS, and in a further embodiment, the transmission may also comprise transmission of a PSCCH associated with the SL PRS and/or a measurement report of the SL PRS. The resource pool is also used for transmission of a signal/channel related to sidelink communication, the transmission of the signal/channel related to sidelink communication comprising transmission of a PSCCH and PSSCH, and possibly transmission of a PSFCH and/or SL-SSB and PSBCH.

In different types of resource pools, SL PRSs and associated PSCCHs thereof may adopt different channel structure designs.

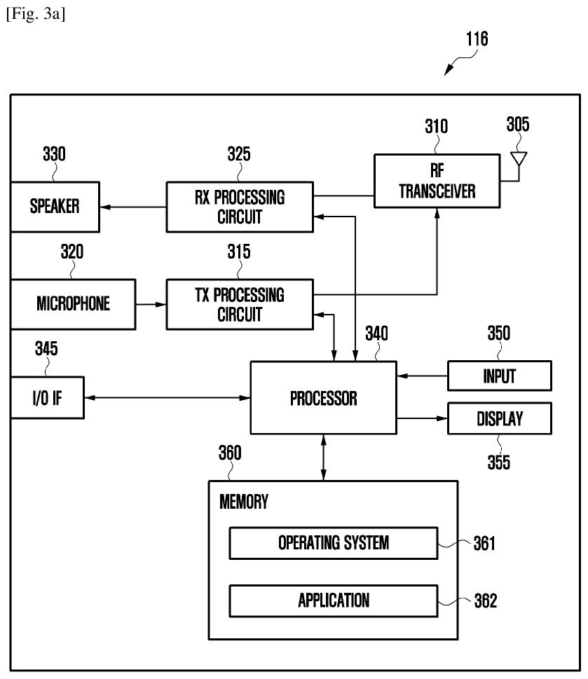

In traditional sidelink communication, scheduling of communication resources is performed in slots in time domain and in subchannels in frequency domain. When a UE transmits sidelink communication using a slot and subchannel, it can be considered that the sidelink channel it transmits occupies all Resource Elements (REs) corresponding to the subchannel on the slot and the subchannel, as illustrated in FIG. 4.

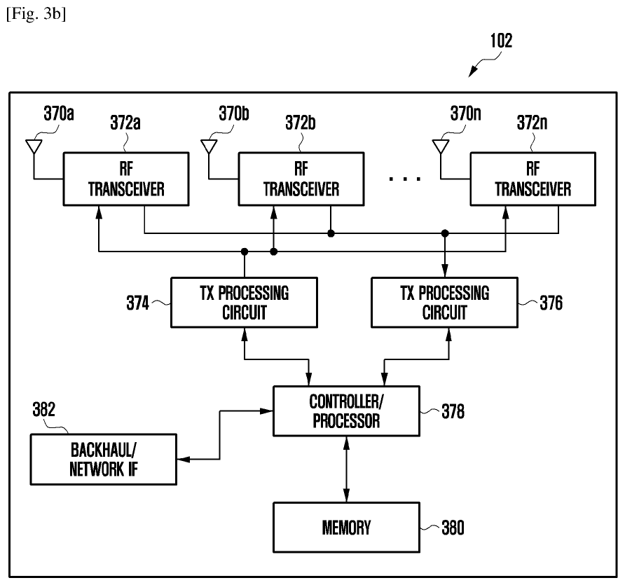

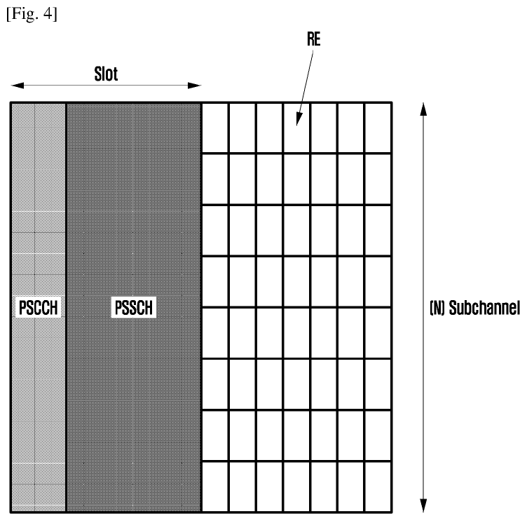

An SL PRS is different from traditional sidelink communication in that, its transmission may be performed in slots in time domain, and in subchannels or Resource Blocks (RB) in frequency domain. When a UE transmits an SL PRS using a slot and subchannel/RB, one SL PRS resource may only occupy the slot and a portion of REs on the subchannel/RB, for example, REs corresponding to a specific resource pattern. FIG. 5 provides two examples in which one SL PRS resource occupies a slot and a portion of REs on a subchannel/RB, wherein colored portions on non-PSSCH resources represent REs occupied by the SL PRS resource. Therefore, when an SL PRS configuration comprises a set of a plurality of SL PRS resources, and there are non-overlapping resources in the set of resources, a plurality of SL PRSs using the non-overlapping SL PRS resources may be multiplexed to be transmitted on same slots and subchannels/RBs. FIG. 6 provides an example in which a plurality of SL PRSs using non-overlapping resources are multiplexed on a same slot and a same frequency-domain resource with a length of N subchannels. In this figure, different pattern fillings are used to distinguish the plurality of SL PRSs. The RE pattern of the SL PRS resources used in this example is Time-Division Multiplexing (TDM), but in other examples, the RE pattern of different SL PRS resources may also be TDM and/or Frequency-Division Multiplexing (FDM), and may have same or different positions of a starting symbol. The protection scope should not be limited by the pattern shown in this example. Wherein, the SL PRS configuration may be system-level or resource pool-level configuration (for example, all the SL PRS configurations allowed in a resource pool), and may or may not be an SL PRS configuration acquired by a sidelink UE. This method may greatly improve utilization efficiency of air interface resources. For example, when the SL PRS configuration of the resource pool comprises 4 non-overlapping SL PRS patterns, a time-frequency resource may be used for up to 4 UEs to transmit SL PRSs corresponding different resource patterns, unlike a data channel, which can only be used for at most 1 UE to transmit its PSSCH. When the resource pool is relatively congested, the effect of this method on improving the throughput and reducing the risk of conflicts is particularly significant.

In an exemplary embodiment, a first UE transmits a sidelink positioning reference signal (SL PRS) to a second UE on a sidelink, and transmits Sidelink Control Information (SCI) of the SL PRS on an associated PSCCH. Additionally/alternatively, the second UE receives the sidelink positioning reference signal (SL PRS) from the first UE on the sidelink, and receives the sidelink control information (SCI) of the SL PRS on the associated PSCCH, and performs reception and/or measurement of the SL PRS according to information indicated by the SCI.

Optionally, when the first UE transmits the SL PRS to the second UE and/or receives the SL PRS from the second UE in the resource pool dedicated to the SL PRS, the resource pool comprises at least a resource for the SL PRS, and may also comprise a PSSCH resource which is at least used to transmit the control information of the SL PRS thereon; and it may also comprise a resource which is used to transmit a measurement result of the SL PRS thereon, which may be PSCCH and/or PSSCH.

Optionally, when the first UE transmits the SL PRS to the second UE and/or receives the SL PRS from the second UE in the resource pool shared with sidelink communication, the resource pool comprises PSCCH resource, PSSCH resource, and resource for the SL PRS. Wherein, the PSSCH resource is at least used for transmitting a PSSCH and/or control information of the SL PRS thereon. Wherein, the first UE may transmit the measurement result of the SL PRS to the second UE on the PSCCH resource and/or the PSSCH resource. Wherein, the resource used for the SL PRS may overlap with the PSCCH resource and/or PSSCH resource, including partially overlapping and/or completely overlapping. This method may also be understood as that the UE may transmit the SL PRS on the PSSCH resource (or a subset thereof).

Optionally, the UE (which may be the first UE and/or the second UE, and may also be considered as the first UE and/or the second UE unless otherwise specified below) determines whether SL PRSs using different SL PRS resources (such as SL PRS resources with different IDs and corresponding SL PRS resources with different RE patterns) can be multiplexed on the same time-frequency resources at least by a configuration related to the SL PRSs; furthermore, the frequency-domain resources comprise RBs and/or subchannels and/or a subchannel group, that is, the UE determines whether the SL PRSs using different SL PRS resources can be multiplexed on the same RBs and/or subchannels and/or subchannel group; additionally/alternatively, the time-domain resources comprise slots and/or symbols, that is, the UE determines whether the SL PRSs using different the SL PRS resources can be multiplexed on the same slots and/or symbols. Wherein, the subchannel group is a set including one or more subchannels, which may be acquired by the UE based on the configuration or pre-configuration from the upper layer/base station.

Optionally, if the UE determines that the SL PRSs using the different SL PRS resources can be multiplexed on the same time-frequency resources, the UE assumes that the SL PRSs using any two configured different SL PRS resources can be multiplexed on the same time-frequency resources. Optionally, if the UE determines that the SL PRSs using the different SL PRS resources can be multiplexed on the same time-frequency resources, the UE further determines which SL PRS resources can be multiplexed on the same time-frequency resources according to the configuration related to the SL PRSs. For example, optionally, at least one SL PRS resource group is provided in the configuration related to the SL PRSs, and all the SL PRS resources in the same group can be multiplexed on the same time-frequency resource; optionally, SL PRS resources in different groups cannot be multiplexed on the same time-frequency resource. For another example, a plurality of SL PRS resources are provided in the configuration related to the SL PRSs, and the UE determines whether RE patterns used by different SL PRS resources overlap according to RE positions occupied by the resources, and then determines any at least two non-overlapping SL PRS resources can be multiplexed on the same time-frequency resource.

Optionally, at least when the time-frequency resources adopted by the SL PRSs using the different SL PRS resources meet at least one of the following conditions, the UE determines that the SL PRSs using the different SL PRS resources can be multiplexed on the same time-frequency resource (the conditions here may not be sufficient conditions, for example, the UE further needs to determine whether the SL PRSs using the different SL PRS resources are multiplexed on the same time-frequency resource based on the configuration related to the SL PRSs, as described in the above method): the starting positions of the time-frequency resources are the same, the ending positions of the time-frequency resources are the same, the time-frequency resource sizes of the time-frequency resources are the same, the time-frequency resources are the same, the time-domain resources are in the same slot, the frequency-domain resources are in the same RB, the frequency-domain resources are in the same subchannel, and the frequency-domain resources are in the same subchannel group.

After applying the above method to multiplex a plurality of SL PRSs into the same time-frequency resource, it is still necessary to solve the problem of how to properly place the control information of the plurality of SL PRSs. In order to ensure that the UE can correctly receive and measure the SL PRSs, the control information of the plurality of SL PRSs multiplexed to the same resource must be transmitted on different PSCCHs respectively; otherwise the problem that the UE fails to perform decoding when a case that control information of at least two SL PRSs is transmitted on overlapping (including partially overlapping) PSCCHs may occur, which may also be referred to as a conflict between PSCCHs. Since there is no design for multiplexing a plurality of PSSCHs to the same resource in existing sidelink systems for sidelink communication, the existing sidelink time-frequency resource (1 slot and 1 subchannel) only comprise 1 PSCCH, and accordingly the prior art cannot solve the PSCCH conflict problem caused by SL PRS multiplexing. Accordingly, it is necessary to improve the channel structure of the PSCCH in the prior art.

### Embodiment One

In order to solve the PSCCH conflict problem caused by SL PRS multiplexing, this embodiment provides a method of defining a plurality of PSSCH resources in each of subchannels or a plurality of subchannels under a current channel structure which is based on a time-frequency resource of a slot and a subchannel. For case of description, a time-frequency resource unit that can be used to transmit a PSCCH is called a PSCCH occasion in this specification.

In this embodiment, one subchannel may comprise a plurality of PSCCH occasions, corresponding to transmission of control information of a plurality of SL PRSs multiplexed on the subchannel; additionally/alternatively, a plurality of subchannels are defined as a subchannel group, which may comprise a plurality of PSCCH occasions, corresponding to transmission of control information of a plurality of SL PRSs multiplexed on the subchannel group.

In this embodiment, the configuration comprises at least one of a configuration by an upper layer, a configuration by a base station, and a pre-configuration.

Optionally, a first UE acquires a configuration of resources of SL PRSs and/or a configuration of a resource pool where the SL PRSs are located, including acquiring a related configuration of a subchannel group used to transmit the SL PRSs. Optionally, the second UE acquires a configuration of resources of SL PRSs and/or a configuration of a resource pool where the SL PRSs are located, including acquiring a related configuration of a subchannel group used to receive the SL PRSs. In various embodiments, the configuration of the resources of the SL PRSs and/or the configuration of the resource pool where the SL PRSs may be acquired from a base station, may be configured by an upper layer, or may be pre-configured in a UE.

Optionally, the related configuration of the subchannel group comprises at least one of the following:
Feature as to whether to enable a subchannel group;
A size of the subchannel group, such as a number of subchannels included in the subchannel group;
Indexes of subchannels included in the subchannel group;
A frequency-domain resource position of at least one subchannel group.

Optionally, the related configuration of the subchannel group also comprises a resource area using a configured subchannel group size, which may be indicated by at least one of an index of a starting and/or ending subchannel, an index of a starting and/or ending Physical Resource Block (PRB). Optionally, when more than one subchannel group size is configured in the resource pool, this method is applied to each configured subchannel group size.

Since an SL PRS requires a larger frequency-domain size (generally much larger than that of traditional sidelink communication) to ensure the measurement precision of the positioning signal, this method may be understood as replacing traditional subchannels with subchannel groups as the minimum resource granularity of SL PRSs. The main advantage of this method is that a plurality of SL PRSs may be transmitted in an aligned manner under the same resource structure (that is, a subchannel group(s)), with the similar effect to traditional sidelink communication where the SL PRSs using a plurality of PSSCHs/PSCCHs are transmitted under the subchannel-based resource structure, which reduces the fragmentation of the resource pool and facilitating more efficiently using the air interface resources; and which may, at the same time, achieve the effect that a plurality of PSCCH occasions are accommodated in a one subchannel group without changing the subchannel structure, thereby helping maintain the forward compatibility of the PSCCH channel structure, and also solving the PSCCH conflict problem caused by SL PRS multiplexing to a certain extent. When a plurality of SL PRSs are transmitted based on a subchannel group(s), ordered mapping between SL PRSs transmitted in one or more subchannel groups and PSCCH occasions in the one or more subchannel groups may be achieved by designing an appropriate mapping rule (corresponding methods provided below).

Optionally, the first UE and/or the second UE acquires a configuration of a resources of SL PRSs and/or a configuration of a resource pool where the SL PRS is located, including acquiring a related configuration of a PSCCH associated with the SL PRS. Optionally, the related configuration of the PSCCH associated with the SL PRS comprises at least one of the following:
Positions of PSCCH resources included in one subchannel. Optionally, the positions comprises time-domain resource positions and/or frequency-domain resource positions of the PSCCH resources, wherein the frequency-domain resource positions further comprise at least one of a starting frequency domain position (such as an index of a starting PRB), an ending frequency domain position (such as an index of an ending PRB), a frequency-domain resource size (such as a number of PRBs), and a frequency-domain resource pattern of the PSCCH resources; and wherein, the PSCCH resources may refer to a set of resources used by all PSCCH occasions included in the subchannel, and correspondingly, the positions may be understood as resource positions of all PSCCH occasions included in one subchannel;
Positions of PSCCH resources included in one subchannel group. Optionally, the resource positions are directly indicated based on the subchannel group, or indirectly indicated through positions of the PSCCH resources included in each subchannel in the subchannel group (which may be preset/configured); and the positions may be understood as resource positions of all PSCCH occasions included in one subchannel group;
A number of PSCCH occasions included in one subchannel;
A number of PSCCH occasions included in one subchannel group. Optionally, the number is indicated directly based on the subchannel group, or indirectly indicated through a number of PSCCH occasions included in each subchannel in the subchannel group;
A time-domain resource size and/or frequency-domain resource size (such as a number of PRBs) of one or each PSCCH occasion;
A time-domain resource position and/or frequency-domain resource position of a starting PSCCH occasion included in one subchannel, wherein the frequency-domain resource position further comprises at least one of a starting frequency-domain position (such as an index of a starting PRB), an ending frequency domain position (such as an index of an ending PRB), a frequency-domain resource size (such as a number of PRBs), and a frequency-domain resource pattern of the starting PSCCH occasion;
A time-domain resource position and/or frequency-domain resource position of a starting PSCCH occasion included in one subchannel group. Optionally, the resource position is directly indicated based on the subchannel group (the specific method is similar to the method of indicating parameters related to a starting PSCCH occasion in a subchannel), or indirectly indicated by a resource position of the starting PSCCH occasion included in a starting subchannel/each subchannel in the subchannel group;
An offset between two adjacent or any two PSCCH occasions, including an offset in time domain and/or frequency domain; furthermore, an offset between any PSCCH occasion and a starting PSCCH occasion.

For the frequency-domain resource pattern of the PSCCHs, a specific example is that, assuming that the subchannel comprises N PRBs, whether every PL RBs indexed from low to high by frequency domain indexes are configured as PSCCH occasions is indicated by a bitmap with a length of N/PL (or rounding up of N/PL), wherein, when the i-th bit in the bitmap is “1”, it is indicated that the i-th (PL RBs) are configured as PSCCH occasions, otherwise it is indicated that they are not configured as PSCCH occasions. Wherein, PL may be a frequency-domain resource size of the PSCCH occasions.

For the number of PSCCH occasion(s) included in one subchannel, a specific example is that, a first UE acquires information as to whether a plurality of PSCCH occasions are included in one subchannel through a related configuration of a PSCCH associated with SL PRSs. Specifically, it may be determined based on a 1-bit field in the configuration that one subchannel comprises one occasion or a plurality of occasions. If a plurality of occasions are comprised, at most N SL PRS resources determined according to the SL PRS configuration may be multiplexed on the same time-frequency resource, and the number of the multiple occasions is also determined to be N. For example, when a UE is configured with SL PRS resources with a parameter of comb-M, according to the RE mapping principle of the comb structure, the UE assumes that there are at most 12/M (if the result is not an integer, then 12/M is rounded down) SL PRSs may be multiplexed on the same time-frequency resource. This method may be understood as the PSCCH configuration explicitly indicating that the number of PSCCH occasion(s) in one subchannel is single or multiple, and then indirectly indicating the number of PSCCH occasion(s) included in one subchannel based on the SL PRS resource configuration (specifically, the multiplexing of SL PRS resources). Another specific example is that, related configuration of the PSCCH associated with the SL PRS comprises a field directly indicating a value of N, where N is the number of PSCCH occasion(s) in one subchannel.

Optionally, the first UE and/or second UE determines a PSCCH occasion according to a preset rule and/or an acquired related configuration of a PSCCH associated with the SL PRS, including determining a resource position of the PSCCH occasion (additionally/alternatively, according to the acquired/determined PSCCH occasion, correspondingly acquires/determines a configuration of the SL PRS or a resource of the SL PRS).

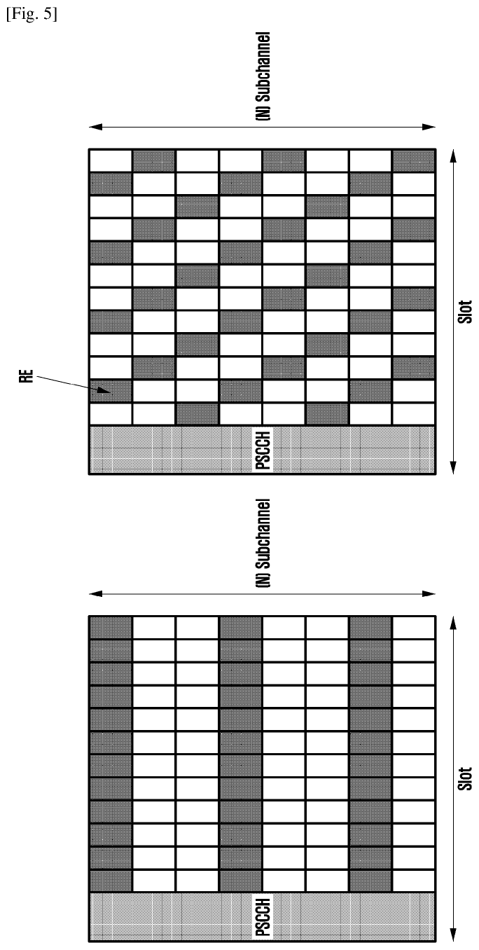

In an exemplary embodiment, the first UE acquires the related configuration of the PSCCH associated with the SL PRS, including one subchannel comprised in N PSCCH occasions and a size of each of the PSCCH occasions. According to the preset rule, the UE determines that the PSCCH occasions start from the PRB with the lowest frequency domain index in the subchannel, and a total of N PSCCH occasions are mapped from low to high by the PRB index. A specific example of this embodiment is provided in FIG. 7. In this example, different pattern fillings are used to distinguish different SL PRS resources and PSCCH occasions corresponding to the resources. The pattern fillings of SL PRS resources and PSCCH occasions corresponding thereto are the same as shown in the figure. In this example, the frequency-domain size of one PSCCH occasion is 1 PRB, but it may also be replaced with being of other lengths.

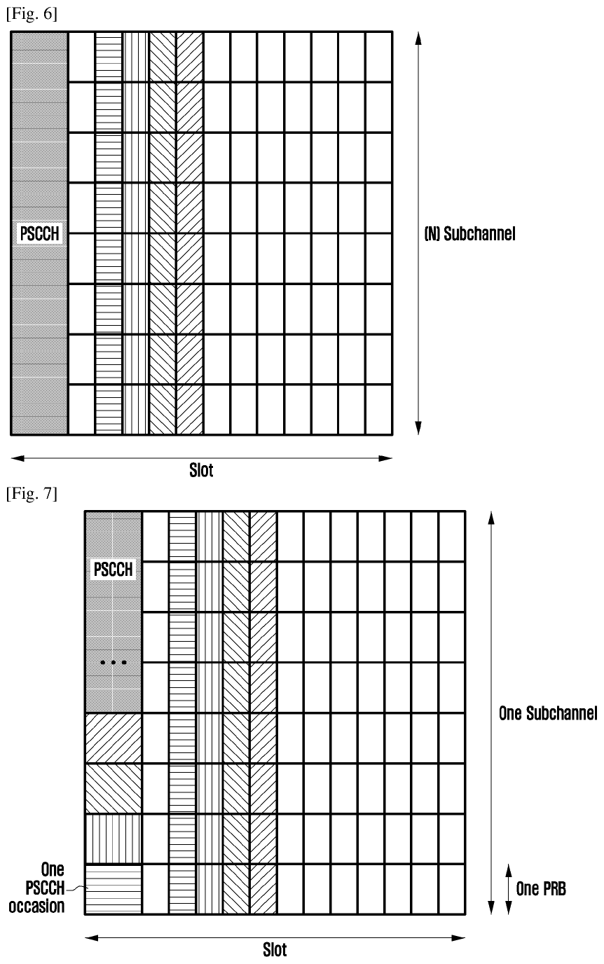

In another exemplary embodiment, the first UE acquires the related configuration of the PSCCH associated with the SL PRS, including enabling subchannel group feature, one subchannel group comprising K subchannels, and one subchannel comprising one PSCCH occasion (alternatively, when the number of PSCCH occasion(s) in one subchannel is not configured, the number may be 1 by default). According to the preset rule, the UE determines that the PSCCH occasions start from the subchannel with the lowest index in the subchannel group, and a total of N PSCCH occasions are mapped from low to high by the subchannel index. A specific example of this embodiment is provided in FIG. 8. In this example, different pattern fillings are used to distinguish different SL PRS resources and PSCCH occasions corresponding to the resources. The pattern fillings of SL PRS resources and PSCCH occasions corresponding thereto are the same as shown in figure. In this example the frequency-domain size of a PSCCH occasion is the same as the frequency-domain size of a subchannel, but may be replaced with being of other lengths that do not exceed the frequency-domain size of the subchannel.

The main advantage of this method is that, when a subchannel is used as a resource unit for transmitting an SL PRS, the channel structure of the PSCCH occasion in a subchannel is sufficient to indicate the control information of all the SL PRSs that may be multiplexed in the subchannel. When this method is used in the resource pool shared with the sidelink communication, the issue of forward compatibility needs to be considered. A feasible method is to make at least one PSCCH occasion compatible with the PSCCH in the sidelink communication system. Accordingly, optionally, when a subchannel comprises a plurality of PSCCH occasions, the time-frequency-domain resource occupied by at least one of the plurality of PSCCH occasions is the same as the PSCCH resource in the sidelink communication system; furthermore, wherein the time-frequency-domain resource occupied by the PSCCH occasion with the lowest frequency domain position (the lowest occupied PRB index) is the same as the PSCCH resource in the sidelink communication system; optionally, this method is used when the resource pool is configured to be shared with the sidelink communication, and this method is not used when the resource pool is configured to be dedicated to SL PRSs (that “this method is not used” may be understood as not limiting whether the time-frequency-domain resource occupied by the above-mentioned PSCCH occasion is the same as the PSCCH resource in the sidelink communication system, which may depend on the base station configuration/UE implementation). The advantage of this method is that, a UE of an older version can detect and decode the SCI of the SL PRS. If the SCI format is designed to enable the UE of the older version to decode the SCI, the UE of the older version may also acquire the control information of the SL PRS, such as occupied time-frequency resource, etc., so that this information is also used in a resource determination process of mode 2 (in which a UE selects a resource for transmission by itself), such that the UE of the older version can also avoid the interference of the SL PRS when selecting the resource for transmission.

In another exemplary embodiment, the first UE acquires the related configuration of the PSCCH associated with the SL PRS, including enabling subchannel group feature, one subchannel group comprising K subchannels, and one subchannel comprising P PSCCH occasions (alternatively, when the number of PSCCH occasion(s) in one subchannel is not configured, the number may by default be 1). According to the preset rule, the UE determines the PSCCH occasions start from the subchannel with the lowest index in the subchannel group, and P PSCCH occasions from low to high by the subchannel index are mapped in each subchannel. The specific pattern is similar to those in other exemplary embodiments above, and will not be drawn repeatedly.

The advantages of using a subchannel group to transmit an SL PRS have been explained above. The main advantage of the method of determining a PSCCH occasion based on a subchannel group is that, when a subchannel group is used as a resource unit for transmitting an SL PRS, the channel structure of the PSCCH occasions in a subchannel group is sufficient to indicate the control information of all the SL PRSs that may be possibly multiplexed in the subchannel group. Similarly, when this method is used in the resource pool shared with sidelink communication, the issue of forward compatibility also needs to be considered. A feasible method is to make at least one PSCCH occasion in each subchannel compatible with the PSCCH in the sidelink communication system. Accordingly, optionally, when each (or at least one) subchannel in the subchannel group comprises a plurality of PSCCH occasions, the time-frequency-domain resource occupied by at least one PSCCH occasion of the plurality of PSCCH occasions is the same as the PSCCH resource in the sidelink communication system; furthermore, wherein the time-frequency-domain resource occupied by the PSCCH occasion with the lowest frequency domain position (the lowest occupied PRB index) is the same as the PSCCH resource in the sidelink communication system; optionally, this method is used when the resource pool is configured to be shared with the sidelink communication, and this method is not used when the resource pool is configured to be dedicated to SL PRSs (that “this method is not used” may be understood as not limiting whether the time-frequency-domain resource occupied by the above-mentioned PSCCH occasion is the same as the PSCCH resource in the sidelink communication system, which may depend on the base station configuration/UE implementation). The advantage of this method is that, a UE of an older version can detect and decode the SCI of the SL PRS. If the SCI format is designed to enable the UE of the older version to decode the SCI, the UE of the older version may also acquire the control information of the SL PRS, such as occupied time-frequency resource, etc., so that this information is also used in a resource determination process of mode 2 (in which a UE selects a resource for transmission by itself), such that the UE of the older version can also avoid the interference of the SL PRS when selecting the resource for transmission. Since UEs of older versions may not have the concept of a subchannel group, optionally, when a UE transmits an SL PRS in at least one subchannel group, the time-frequency resource used by the SL PRS is indicated in the SCI based on a subchannel and/or subchannel group; optionally, when a first UE transmits an SL PRSs to a second UE in at least one subchannel group, in the case of the resource pool being configured to be shared with the sidelink communication, the time-frequency resource used by the SL PRS is indicated in the SCI based on a subchannel, and in the case of the resource pool being configured to be dedicated to SL PRS, the time-frequency resource used by the SL PRS may be indicated in the SCI based on a subchannel and/or subchannel group.

In the above exemplary embodiments, the first UE determines the frequency-domain positions of the PSCCH occasions (including the starting PSCCH occasion) according to the preset rule; and the time-domain positions thereof are assumed to occupy all time-domain resource positions configured to the PSCCH occasions according to the preset rule. If the related information is indicated in the configuration, the first UE may also determine the time-domain and/or frequency-domain positions of the PSCCH occasions according to the information indicated in the configuration.

The above method illustrates the channel structure of the PSCCH used to transmit the control information of the SL PRS. Optionally, the PSCCH is used to transmit first-stage (1st stage) SCI. If the control information of the SL PRS further comprises second-stage SCI, the PSCCH may further be used to transmit the second-stage SCI, and/or, a plurality of resources for transmitting second-stage SCI corresponding to different SL PRSs are determined,
using a method similar to the above-mentioned method for determining the occasions of the PSCCHs. For example, parameters related to the resources used to transmit the second-stage SCI, such as size of the resources, are acquired from an upper layer/base station/pre-configuration. For specific parameters, refer to the example of PSCCH occasion. For another example, starting from the first symbol after the PSCCH resource and in an order from low to high in the frequency domain, the plurality of resources for transmitting the second-stage SCI corresponding to the different SL PRSs are determined in one subchannel and/or each subchannel in one subchannel group. For the specifics of the method, refer to the example of PSCCH occasion.

Optionally, Orthogonal Frequency Division Multiplexing (OFDM) symbols used for transmitting the second-stage SCI are not used for transmission of the SL PRS. The number of the symbols may be preset/(pre-) configured, for example, indicated in the resource pool configuration, or may be calculated based on at least one of the second-stage SCI format, the frequency-domain resources of the subchannel/subchannel group, the number of resources used to transmit the second-stage SCI in one subchannel/subchannel group. For example, according to the length of the second-stage SCI format (if a plurality of lengths of the second-stage SCI format are defined in the system, the length may be the length configured in the resource pool and/or the longest length defined in the system, which may be determined based on whether the resource pool is shared with the sidelink communication or dedicated to SL PRSs and accordingly based on or not based on the second-stage SCI format corresponding to the sidelink communication), the number of REs used to transmit a second-stage SCI format is calculated as P, and according to there being a total of N resources used to transmit the second-stage SCI in one subchannel/subchannel group, the total number of REs used to transmit a plurality of second-stage SCI formats is calculated as P*N, and then according to the frequency domain size of the subchannel/subchannel group being m REs (converted from the number of PRBs), the number of the OFDM symbols used to transmit the second-stage SCI is determined to be rounding up of P*N/m.

Optionally, after determining that a total of K OFDM symbols in the slot are used for transmitting the second-stage SCI, for each resource used for transmitting the second-stage SCI, the UE sequentially maps the second-stage SCI on the K OFDM symbols in the manner of time domain first and then frequency domain. This method is opposite to the method in the sidelink communication which is performed in the manner of frequency domain first and then time domain. The reason is that the mapping order of time domain first is chosen in the sidelink communication to reduce the delay, and the transmission of the second-stage SCI is equivalent to puncture the REs used for the PSSCH. The generated second-stage SCI and PSSCHs are TDM and/or FDM, and may still occupy each RE of the PSSCH resources. And when an SL PRS cannot be transmitted on the OFDM symbols used for the second-stage SCI, and the channel structure needs to support transmission of multiple pieces of second-stage SCI using different resources while a single UE on the transmitting end will only transmit a piece of second-stage SCI, if the rule in the sidelink communication is reused, it may occur that a specific piece of second-stage SCI is mapped to one (or less than K) of the K OFDM symbols, and for the remaining OFDM symbols to which the second-stage SCI is not mapped to, from the perspective of the UE transmitting the second-stage SCI, these OFDM symbols may be blank, which will cause hopping in the transmission power between symbols, thereby causing the Automatic Gain Control (AGC) concern.

Optionally, the first UE transmits an SL PRS and associated SCI to the second UE and/or receives the SL PRS and the associated SCI from the second UE, including at least one of the following:
According to correspondence between SL PRSs and PSCCHs, transmitting the SL PRS and correspondingly transmitting associated SCI; and/or according to the correspondence between the SL PRSs and the PSCCHs, receiving the SCI and correspondingly receiving the associated SL PRS; wherein, the SCI is transmitted on a PSCCH; and
receiving the SCI and receiving the SL PRS according to information on the SL PRS indicated in the SCI; and/or transmitting the SCI and the SL PRS and indicating the information on the SL PRS in the SCI.

Wherein, the correspondence between the SL PRSs and the PSCCHs comprises correspondence between SL PRS resources and the PSCCH resources; additionally/alternatively, correspondence between a set of SL PRS resources and the PSCCHs.

Optionally, the correspondence between the SL PRSs and the PSCCHs comprises correspondence between SL PRS resources (for example, a RE-level resource pattern) and PSCCH occasions, for example, a mapping relationship between indexes of the SL PRS resources and indexes of the PSCCH occasions; wherein, the indexes of the SL PRS resources may be indicated by an RRC field, and/or obtained by mapping according to the SL PRS resource IDs (similar to an ID of a DL PRS resource indicated by nr-DL-PRS-ResourceID in downlink synchronization). Optionally, the correspondence between the SL PRSs and the PSCCHs comprises correspondence between an SL PRS resource set and the PSCCH occasions, for example, a mapping relationship between an index of the SL PRS resource set and indexes of the PSCCH occasions; wherein, the index of the SL PRS resource set may be indicated by an RRC field, and/or obtained by mapping according to an SL PRS resource set ID (similar to an ID of a DL PRS resource set indicated by nr-DL-PRS-ResourceSetID in downlink synchronization). For the mapping between the SL PRS resource IDs and the indexes, and/or the mapping between the SL PRS resource set ID and indexes, a specific example is that, an index of an SL PRS resource (which can also be replaced by a resource set in this example)=(SL PRS resource ID+offset) mod N, where mod is a remainder operation, and N is a positive integer; and optionally, N is the maximum value of the indexes of the PSCCH occasions (corresponding to the SL PRS resources) or the total number of the PSCCH occasions (corresponding to the SL PRS resources). Another specific example is that, which SL PRS resources are included in an SL PRS resource set is configured through a RRC parameter (for example, similar to the dl-PRS-ResourceList parameter in the DL PRS), in which the index of each SL PRS resource is configured, or the order of each SL PRS resource in this parameter determines the indexes of the SL PRS resource.

Wherein, the indexes of the PSCCH occasions may be explicitly indicated in a configuration (for example, when a time-domain and/or frequency-domain position of a PSCCH occasion is indicated, its index is also indicated), or be obtained by ordering the PSCCH occasions according to the time-frequency-domain resource positions of the PSCCH occasions. Optionally, the indexes of the PSCCH occasions are obtained by ordering the PSCCH occasions in an ascending order in the frequency domain in one subchannel; for example, in FIG. 7, the indexes of four PSCCH occasions shown in the figure are 0˜3 from bottom to top. Optionally, the indexes of the PSCCH occasions may be obtained by ordering the PSCCH occasions in the manner of ascending order in the frequency domain of the subchannels first in one subchannel group and then ascending order of PRBs in the subchannels. For example, in FIG. 8, the indexes of the four PSCCH occasions shown in the figure are 0˜3 from bottom to top. For another example, assuming there are 4 subchannels in one subchannel group, and there are 2 PSCCH occasions in each subchannel, the indexes of the PSCCH occasions may be obtained by ordering the PSCCH occasions in the manner of ascending order in the frequency domain of the subchannels first and then ascending order of PRBs in the subchannels, wherein the two PSCCH occasions in the subchannel #0 are indexed as PSCCH occasion #0 and PSCCH occasion #1 in the order from low to high in the frequency domain, and the two PSCCH occasions in the subchannel #1 are indexed as PSCCH occasion #2 and PSCCH occasion #3 in the order from low to high in the frequency domain, and so on.

Optionally, the first UE determines that one subchannel comprises one or more PSCCH occasions based on a (pre) configuration. The first UE determines the SL PRS resources used for transmitting the SL PRS based on the (pre) configuration, and determines the PSCCH occasions corresponding to the SL PRS resources based on the correspondence between the SL PRSs and the PSCCHs. The first UE transmits the SL PRS and the SCI of the SL PRS on the determined SL PRS resources and PSCCH occasion, respectively. Furthermore, when the SL PRS resources comprise a plurality of subchannels in the frequency domain, the PSCCH occasion corresponding to the SL PRS pattern is determined according to at least one of the following:
In the subchannel with the lowest index, it is determined based on the correspondence between the SL PRSs and the PSCCHs; for example, when the index of the SL PRS pattern is N, the corresponding PSCCH occasion is the PSCCH occasion with the index of N in the subchannel with the lowest index;
In all subchannels, it is determined based on the correspondence between the SL PRSs and the PSCCHs; for example, when the SL PRS pattern index is N, the PSCCHs in all subchannels are ordered in ascending order in the frequency domain, and the PSCCH occasion with an index of N is selected as the PSCCH occasion corresponding to the SL PRS pattern; for another example, when the SL PRS pattern index is N, the PSCCH occasion corresponding thereto is the PSCCH occasions with the index of N in each subchannel, and the first UE may select (for example, randomly select) among these PSCCH occasions a PSCCH occasion with index of N in at least one subchannel as the PSCCH occasion corresponding to the SL PRS pattern.

Optionally, the second UE determines that one subchannel comprises one or more PSCCH occasions based on a (pre) configuration. The second UE determines the SL PRS resources used to receive the SL PRS based on the (pre) configuration, and determines the PSCCH occasions corresponding to the SL PRS resources based on the correspondence between the SL PRSs and the PSCCHs. Alternatively, the second UE determines the SL PRS resources corresponding to the PSCCH based on the detected PSCCH and based on the correspondence between the SL PRSs and the PSCCHs. The second UE receives the SL PRS and the SCI of the SL PRS on the determined SL PRS resources and PSCCH occasions, respectively. Furthermore, when the SL PRS resources configured in the resource pool and/or configured for the first UE comprise a plurality of subchannels in the frequency domain, the second UE determines the PSCCH occasion corresponding to the SL PRS pattern according to the at least one of the above.

In the above methods, subchannels may also be replaced by subchannel groups, and a method similar to the above may be used to figure out how to determine the corresponding PSCCH occasion when the SL PRS resources comprises a plurality of subchannel groups in the frequency domain.

### Embodiment Two

In order to solve the PSCCH conflict problem caused by SL PRS multiplexing, this embodiment provides a method of defining a PSCCH resource (which may also be replaced by a PSCCH occasion in Embodiment One) based a resource pool, and determining one of a PSCCH resource and an SL PRS source based the other of the two through a resource mapping rule between PSCCHs and SL PRSs, and transmitting the SL PRS and control information thereof accordingly.

In this embodiment, a configuration comprises at least one of a configuration by an upper layer, a configuration by a base station, and a pre-configuration.

Optionally, a first UE and/or a second UE acquires a configuration of resources of SL PRSs and/or a configuration of a resource pool where the SL PRSs are located, including acquiring a related configuration of PSCCHs associated with the SL PRSs. Optionally, the related configuration of the PSCCHs associated with the SL PRSs comprises at least one of the following:
A PSCCH period, which is used to indicate a number of time units corresponding to a period of PSCCH resources in a resource pool, and/or indicate a period of slots (or which may also be replaced by other time units) containing the PSCCH resources appearing in the resource pool; optionally, the period is calculated based on logic slots of the resource pool; more specifically, the PSCCH period is the period of the time units containing the PSCCH resources (which may also be PSCCH occasions, the case is similar hereinafter), that is, the PSCCHs are periodic in the resource pool, and not every time unit (such as a slot) in the resource pool has a PSCCH resource; in a specific example, a value of N of the PSCCH period indicates that that each PSCCH period in the resource pool comprises N slots, wherein the first slot in each PSCCH period comprises a PSCCH resource, and the other slots do not contain a PSCCH resource; for this period, the UE is provided (configured) with the number of slots (or other time units) of the period of the PSCCH resources in the resource pool; for example, in the above specific example, the UE is provided with the value of N;
Total PSCCH frequency-domain resources in a resource pool, further comprising at least one of a starting PRB, a frequency-domain size, an ending PRB, and a RB index of all the PSCCH frequency-domain resources (which may be indicated in the form of a bitmap, for example, a bitmap with a length size equal to the number of RBs in the frequency domain of the resource pool is configured, in which a bit set to “1” indicates that the RB is configured to a PSCCH resource):
A frequency-domain resource of a PSCCH resource (similar to a PSCCH occasion in Embodiment One, for transmitting a PSCCH), further comprising at least one of a starting PRB, a frequency-domain size, an ending PRB, and a RB index of the PSCCH;
An index of a PSCCH resource, which may be acquired from in a configuration, or may be acquired according to a predefined rule, for example, for all PSCCH resources on a slot (and/or on a subchannel), indexes thereof are acquired by ordering them from low to high in the frequency domain.

Optionally, within a PSCCH period that comprises a total of no more than

$${N}_{SLPRS}^{PSCCH}$$

slots, one slot containing PSCCH resources is included, and remaining slots may be used for transmission of SL PRSs, if the SL PRSs can be transmitted in the same slot as the PSCCH (for example in the form of TDM and/or FDM) then the slot containing the PSCCH resources may also be used for transmission of the SL PRSs.

Optionally, the one slot containing the PSCCH resources comprises

$${M}_{PRB , set}^{PSCCH}$$

PRBs configured for the PSCCH, which are used for N^{PSCCH} PSCCH resources, and each PSCCH resource comprises k PRBs in the frequency domain,

$${M}_{PRB , set}^{PSCCH} = k * {N}^{PSCCH} .$$

Optionally, the N^{PSCCH} PSCCH resources are indexed in an ascending order (which may be the ascending order of PRB indexes) in the frequency domain.

Optionally, the first UE and/or the second UE determines corresponding PSCCH resources based on configured SL PRS resources according to a resource mapping rule between SL PRSs and the PSCCHs (additionally/alternatively, determines corresponding SL PRS resources according to a configured PSCCH resource or a PSCCH resource used by a PSCCH detected (by the second UE)).

Optionally, the resource mapping rule comprises mapping in the time domain. Optionally, when the first UE transmits a PSCCH to the second UE in slot n, an SL PRS associated with the PSCCH is transmitted no earlier than slot n+k (optionally, if the SL PRS occupies a plurality of slots, for example, a repetition factor is configured, n+k corresponds to the starting slot and/or ending slot thereof); optionally, if the first UE transmits an SL PRS in slot n, a PSCCH associated with the SL PRS is transmitted in a latest slot comprising a PSCCH resource no later than slot n-k (optionally, if the SL PRS occupies a plurality of slots, for example, if a repetition factor is configured, n corresponds to the starting slot and/or ending slot thereof); where k may be a logic slot of the resource pool, and its physical meaning may be a processing latency and/or a scheduling interval. When the value of k is 0, it corresponds to scheduling in the same slot, that is, the PSCCH schedules SL PRS resources of the same slot, and when k>0 it corresponds to cross-slot scheduling.

Optionally, the resource mapping rule comprises mapping in the frequency domain. Furthermore, the mapping is performed based on frequency domain positions of the SL PRS resources and frequency domain positions and/or indexes of the PSCCH resources, comprising, for SL PRS resources in a PSCCH period, PSCCH resources are allocated to one or more SL PRS resources sequentially on each time-frequency resource (for example, a subchannel on a slot being one time-frequency resource) in a manner of ascending order in time domain first and then ascending order in frequency domain, or in a manner of ascending order in frequency domain first and then ascending order in time domain. The PSCCH resources may be allocated in an ascending order of indexes of the PSCCH resources.

Specifically, for N_{subch} subchannels in a resource pool, and a total of no more than

$${N}_{SLPRS}^{PSCCH}$$

slots in a PSCCH period, when an SL PRS is transmitted in the i-th slot of the no more than

$${N}_{SLPRS}^{PSCCH}$$

slots and on the j-th subchannel of the N_{subch} subchannel, the first UE allocates the

$$[ ( i + j \cdot {N}_{SLPRS}^{PSCCH} ) \cdot {M}_{subch , slot}^{PSCCH} , ( i + 1 + j \cdot {N}_{PSSCH}^{PSFCH} ) \cdot {M}_{subch , slot}^{PSFCH} - 1 ] - th$$

PSCCH of a total of N^{PSCCH} PSCCH resources in one slot to the SL PRS, where

$${M}_{subch , slot}^{PSCCH} = {N}^{PSCCH} / ( {N}_{subch} \cdot {N}_{SLPRS}^{PSCCH} ) , 0 \leq i < {N}_{SLPRS}^{PSCCH} , 0 \leq j < {N}_{subch} .$$

The allocation is done in the order of time domain first and then frequency domain (ascending order for i first and then ascending order for j). The mapping rule can be understood as that, the first UE first allocates the very starting (first)

$${M}_{subch , slot}^{PSCCH}$$

PSCCH resources to the SL PRS resources on subchannel #0 and in the first slot in the PSCCH period, and then allocates the subsequent (second)

$${M}_{subch , slot}^{PSCCH} PSCCH$$

resources to the SL PRS resources on subchannel #0 and in the second slot in the PSCCH period, . . . , and so on; then allocates the

$$( {N}_{SLPRS}^{PSCCH} + 1 ) - th {M}_{subch , slot}^{PSCCH} PSCCH$$

resources to the SL PRS resources on subchannel #1 and in the first slot in the PSCCH period, and then allocates the

$$( {N}_{SLPRS}^{PSCCH} + 2 ) - th {M}_{subch , slot}^{PSCCH} PSCCH$$

resources to the SL PRS resources on subchannel #1 and in the second slot in the PSCCH period, . . . , and so on, until corresponding

$${M}_{subch , slot}^{PSCCH} PSCCH$$

resources are allocated for each slot in a PSCCH period and SL PRS resources on the subchannels. Optionally, the first UE may also perform the allocation in the order of frequency domain first and then time domain, and according to a rule similar to the above.

Optionally, the mapping further comprises: when a plurality of SL PRS resources can be multiplexed on the same time-frequency resource (similar to Embodiment One), corresponding one or more PSCCH resources are allocated for each of SL PRS resources that can be multiplexed on each subchannel in each slot. The method is combined with time-domain and frequency-domain mapping, and further comprises, for SL PRS resources in a PSCCH period, PSCCH resources are allocated to each of SL PRS resources sequentially in a manner of ascending order in time domain first and then ascending order of indexes of SL PRS resources, or in a manner of ascending order in frequency domain first and then ascending order of indexes of SL PRS resources. The PSCCH resources may be allocated in an ascending order of indexes of the PSCCH resources.

Optionally, in a total of

$${M}_{subch , slot}^{PSCCH}$$

resources allocated to the SL PRS on the j-th subchannel and in the i-th slot according to the above method, the PSCCH resource with the lowest index is allocated to the SL PRS resource with the lowest index of the plurality of multiplexed SL PRSs, the PSCCH resource with the second lowest index is allocated to the SL PRS resource with the second lowest index of the plurality of multiplexed SL PRSs, . . . , and so on. Optionally, when a total of P SL PRS resources can be multiplexed on the same time-frequency resource (similar to Embodiment One), in the total of

$${M}_{subch , slot}^{PSCCH}$$

resources allocated to the SL PRS resource on the j-th subchannel and in the i-th slot according to the above method,

$${M}_{subch , slot}^{PSCCH} / P PSCCH$$

resources with the lowest index are allocated to the SL PRS resources with the lowest index of the plurality of multiplexed SL PRS resources,

$${M}_{subch , slot}^{PSCCH} / P PSCCH$$

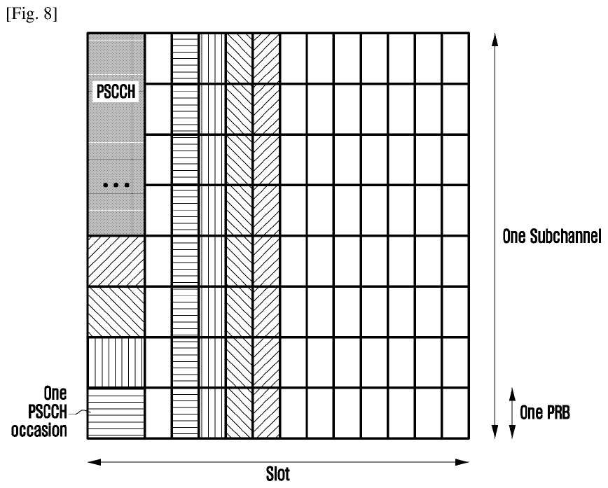

resources with the second lowest index are allocated to the SL PRS resources with the second lowest index of the plurality of multiplexed SL PRS resources, . . . , and so on; wherein, the indexes of the SL PRS resources are acquired in a similar manner to that in Embodiment One. A specific example of this method is shown in FIG. 9. In this example, one subchannel is taken as an example, and the mapping relationship between a plurality of SL PRS resources multiplexed on the same time-frequency resource in a plurality of slots and PSCCH resources corresponding thereto is provided. In the figure, different pattern fillings are used to distinguish different SL PRS resources and corresponding PSCCH resources, wherein one SL PRS resource and corresponding PSCCH resource use the same pattern filling.

Optionally, if the SL PRS resources selected by the first UE comprise a plurality of subchannels, the first UE maps and acquires corresponding PSCCH resource based on the subchannel with the lowest index in the plurality of subchannels according to the above method; and/or; maps and acquires the corresponding PSCCH resource based on all of the subchannels according to the above method. For example, corresponding PSCCH resources are mapped and acquired for each of the subchannels respectively, and the PSCCH resources corresponding to the SL PRS are a resource set including PSCCH resources corresponding to each of the subchannels.

Optionally, if the first UE has acquired a plurality of PSCCH resources for transmitting control information corresponding to an SL PRS, the first UE transmits the control information corresponding to the SL PRS to the second UE on all of the plurality of PSCCH resources, comprising mapping the control information to all of the plurality of PSCCH resources, and/or transmitting the control information repeatedly on the plurality of PSCCH resources; or the first UE transmitting the control information corresponding to the SL PRS on a subset of the plurality of PSCCH resources, comprising mapping the control information to the subset, and/or transmitting the control information repeatedly on the subset. For the latter, in a specific example, the first UE selects a PSCCH resource with the lowest index from the plurality of PSCCH resources, or randomly selects one PSCCH resource therefrom, and transmits the control information corresponding to the SL PRS on the selected one PSCCH resource. Optionally, the second UE detects the PSCCH from the first UE on each of PSCCH resources, and/or detects the PSCCH from the first UE on the plurality of PSCCH resources or a subset thereof. Optionally, if the second UE has acquired the related configuration of the SL PRS of the first UE, and determines the resource used by the first UE to transmit the PSCCH or the size of the resource, the PSCCH from first UE is detected on the PSCCH resource based on the resource or the size of the resource.

Optionally, if the first UE has acquired the configuration related to a subchannel group (the specific details are similar to those in Embodiment One), the subchannels in the above method may also be replaced by the subchannel group.

The above method may be considered as a case that a resource mapping rule is preset between the SL PRS resources and the PSCCH resources, such that the UE can determine one of the SL PRS resources and the PSCCH resources from the other without indication by additional signaling, thereby reducing the signaling overhead; and at the same time, it can be seen that the effects of the above mapping rule comprise that, when the SL PRS resources are different, the corresponding PSCCH resources are also different, such that the conflict between the PSCCH resources and other interferences may be readily avoided if only avoiding the conflict between the SL PRS resources and other interferences is considered when the UE selects resources on its own, thereby reducing the complexity of resource selection by the UE.

The above illustration in Embodiment Two provides a method based on a fixed mapping rule, and in this embodiment, a method based on a dynamic indication may also be considered. This method uses a PSCCH channel structure similar to that in the above method of a fixed mapping rule, that is, within a PSCCH period in a resource pool, there is one slot containing a PSCCH resource, and the slot comprises a plurality of PSCCH resources. Optionally, a UE selects at least one of the plurality of PSCCH resources to transmit control information associated with an SL PRS, and explicitly indicates (instead of indirectly indicating through a mapping rule) a resource used by the associated SL PRS in the control information; the indicated information may comprise at least one of the following: a time domain position (which may be indicated by a slot index and/or a gap between a PSCCH and an SL PRS), a frequency domain position (which may be indicated by at least one parameter of a subchannel index and a PRB index) and other information corresponding to parameters in an SL PRS configuration (similar to Embodiment One). The advantage of this method is that it is more flexible, and the method can use a structure similar to that in the sidelink communication system, in which information of a plurality of SL PRS resources (and/or multiple repetitions of one SL PRS resource) is indicated in one PSCCH information, thereby reducing the control signaling overhead. However, in this method, the UE needs to additionally determine resources for transmitting the PSCCH. Optionally, the UE randomly selects the resources for transmitting the PSCCH, or selects them based on channel monitoring. For the random selection, in order to reduce conflicts, optionally, the number of resources configured to a slot containing PSCCH resources in the resource pool may be greater than (much greater than) the number of SL PRS resources in a PSCCH period (which may be determined by the number of slots in the period*(the number of subchannels, or the number of subchannels minus the SL PRS frequency-domain size (in the number of subchannels)+1)*the maximum number of SL PRS resources that can be multiplexed on time-frequency resources), so as to improve the randomness of the UE selecting the PSCCH resources.

Similarly, if the UE acquires a configuration related to a subchannel group (the specific details are similar to those in Embodiment One), the subchannels in the above method may also be replaced by a subchannel group.

After the SL PRS and the corresponding PSCCH resource are determined using the method in Embodiment Two, the subchannel where the SL PRS is located and the PSCCH resource in the slot may be further determined using the method in Embodiment One. Optionally, the first-stage SCI is transmitted on the PSCCH resource determined by the method in the Embodiment Two, and the second-stage SCI is transmitted on the PSCCH resource determined by the method in Embodiment One. Although the resources used to transmit the second-stage SCI in the traditional sidelink communication system is not a PSCCH resource, the PSCCH resources in this specification are mainly used to illustrate that the resources re used to transmit the control information of SL PRSs, and do not need to be strictly in line with the definition of a PSCCH resource in the traditional system.

Since the method in the Embodiment Two modifies the PSCCH channel structure in the sidelink communication system, it is more suitable for the resource pool dedicated to SL PRSs. Optionally, whether to use the method in the Embodiment Two is determined according to the type of resource pool; for example, this method is used in a resource pool dedicated to SL PRSs, and the method in other embodiments is used in a resource pool shared with the sidelink communication.

### Embodiment Three

In order to solve the PSCCH conflict problem caused by SL PRS multiplexing, this embodiment provides a method of transmitting an SL PRS and control information thereof based on same-slot/cross-slot scheduling and stand-alone SCI when reusing the PSCCH channel structure in sidelink communication.

In this embodiment, a first UE acquires a configuration of resources of an SL PRS and/or a configuration of a resource pool where the SL PRS is located, and the first UE also acquires a related configuration of a PSCCH associated with the SL PRS, further comprising: using PSSCH resources configured for sidelink communication in the resource pool as resources available for SL PRS transmission, and/or using a related configuration of PSCCH for sidelink communication also as a PSCCH associated with the SL PRS.

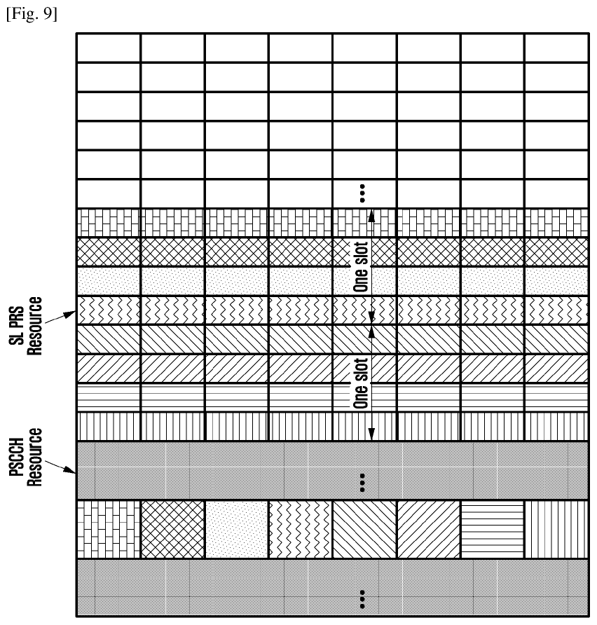

Optionally, the first UE transmits an SL PRS and control information of the SL PRS to a second UE, comprising transmitting SCI associated with the SL PRS on a PSCCH resource in slot n, wherein control information of the SL PRS to be transmitted in slot m is indicated in the SCI. In this method, n and m may be equal (which may be referred to as same-slot scheduling) or unequal (which may be referred to as cross-slot scheduling). FIG. 10 illustrates two examples in which n=m (in shaded blocks with vertical lines in FIG. 10, shaded blocks with dark vertical lines represent SCI and shaded blocks with light vertical lines represent SL PRS) and n<m (in shaded blocks with horizontal lines in FIG. 10, wherein shaded blocks with dark horizontal lines represent SCI and shaded blocks with light horizontal lines represent SL PRS). In addition, n>m is also a feasible method, in which the UE may buffer the signal/channel received in slot m first, and then attempt to decode/measure the signal/channel buffered in slot m after acquiring the control information in slot n.

Optionally, the first UE determines whether to support same-slot scheduling and/or whether to support cross-slot scheduling according to a preset rule or configuration. If only the same-slot scheduling is supported, time-domain positions of the SL PRS resources do not need to be indicated in the control information of the SL PRS. If at least cross-slot scheduling is supported, a mechanism similar to that in sidelink communication is used to indicate the time-domain positions of the SL PRS resources.

Optionally, the PSSCH resources corresponding to the PSCCH resources used by the first UE to transmit the control information of the SL PRS to the second UE may be used for at least one of the following:
Transmitting the SL PRS, for which a specific example is illustrated in shaded blocks with vertical lines in FIG. 10. Shaded blocks with dark vertical lines in this figure are PSCCH resources, and shaded block portions with light vertical lines in the slots and subchannels where the PSCCH resources are located represent PSSCH resources, which are used to transmit the SL PRS;
Transmitting a PSSCH; for example, the first UE transmits SCI associated with SL PRS to the second UE on a PSCCH resource in slot n, and transmits the PSSCH (and second-stage SCI associated with the PSSCH resource) on a PSSCH resource corresponding to the PSCCH resource; and the PSSCH may be used to transmit data of sidelink communication. A specific example is illustrated in shaded blocks with horizontal lines in FIG. 10, in which left portions of shaded blocks with dark horizontal lines in the figure represent PSCCH resources, and right portions of slots and subchannels where the PSCCH resources are located represent PSSCH resources, which may be used to transmit data of the sidelink communication;
Not being used to transmit an SL PRS or PSSCH; for example, the first UE transmits SCI associated with the SL PRS to the second UE on a PSCCH resource in slot n, and transmits second-stage SCI on a PSSCH resource corresponding to the PSCCH resource, and/or does not transmit a PSSCH on the PSSCH resource corresponding to the PSCCH resource (but a dummy signal may be transmitted to keep the transmission power from hopping, so as to avoid the AGC issue).

It should be noted that in FIG. 10, not all PSCCH resources in the resource pool are specially shown. For example, although light portions of shaded bocks with vertical lines and horizontal lines are labelled as PSSCH resources, there may also be PSCCH resources in slots and subchannels of these resources, such as PSCCH resources with a channel structure similar to that in the sidelink communication resource pool.

Wherein, the PSSCH resources corresponding to the PSCCH resources comprise at least PSSCH resources in slots and on subchannels where the PSCCHs are located.

For the method in which PSSCH resources are not used to transmit an SL PRS or PSSCH, in this method, SCI indicating SL PRS control information may be transmitted on a PSCCH. This SCI is also referred to as stand-alone SCI, transmission of which occupies at least one subchannel on a slot. Although the stand-alone SCI has no associated PSSCH, other UEs still need to try to avoid transmission on a PSCCH resource and PSSCH resource in the slot and on the subchannel. The advantage of this method is that, since an SL PRS typically requires a larger resource (precision requirement for positioning measurement usually lead to a larger number of PRBs occupied by the SL PRS in the frequency domain), when there are some relatively fragmented resources in the resource pool, these resources may be used to transmit control information of the SL PRS, thereby effectively utilizing the fragmented resources; and the sensing mechanism in the sidelink communication may be multiplexed among control information of a plurality of SL PRSs multiplexed on the same time-frequency resource, to choose different fragmented resources so as to avoid conflicts.

For the above method in which a PSSCH resource is used to transmit a PSSCH, optionally, for the PSCCH resource and corresponding PSSCH resource used by the first UE to transmit control information of an SL PRS, the control information of the PSSCH transmitted by the first UE on the PSSCH resource may be indicted in second-stage SCI associated with the PSSCH, and/or indicated in the PSCCH resource.

Optionally, the method in which the first UE transmits the PSSCH and the SL PRS to the second UE, and indicates the control information of the SL PRS and/or the control information of the PSSCH in the PSCCH resource comprises at least one of the following:
Transmitting an SCI format associated with an SL PRS and an SCI format associated with a PSSCH on a PSCCH resource. Optionally, the SCI format associated with the PSSCH is first mapped in ascending order in the frequency domain on the OFDM symbols used for the PSCCH, and then the SCI format associated with the SL PRS is mapped. The mapping order is mainly for backward compatibility, so that the UE performing sidelink communication in the system can at least resolve the SCI format associated with the PSSCH;
Transmitting the SCI format associated with the SL PRS on the PSCCH resource, and indicating the resource used by the PSSCH in the SCI format;
Transmitting the SCI format associated with the PSSCH on the PSCCH resource, and also indicating the resource used by the SL PRS in the SCI format;
Transmitting the SCI format associated with SL PRS on the PSCCH resource, and transmitting the SCI format associated with the PSSCH on the PSSCH resource corresponding to the PSCCH resource; for example, by using the method of transmitting the second-stage SCI format of the PSSCH on the PSSCH resource in the sidelink communication system;
Transmitting the SCI format associated with the PSSCH on the PSCCH resource, and transmitting the SCI format associated with the SL PRS on the PSSCH resource corresponding to the PSCCH resource; for example, by reusing the method of transmitting the second-stage SCI of the PSSCH on the PSSCH resource in the sidelink communication system, the first-stage and/or second-stage SCI format of the SL PRS is transmitted on the PSSCH resource.

Accordingly, the second UE receives the PSCCH and acquires the control information of the SL PRS and/or the control information of the PSSCH according to at least one of the above methods, and receives the PSSCH and SL PRS according to the control information.

Optionally, in the above method, unless otherwise specified, the SCI format transmitted on the PSCCH resource comprises the first-stage SCI format, and the SCI format transmitted on the PSSCH resource or SL PRS resource (or not on the PSCCH resource) comprises the second-stage SCI format.

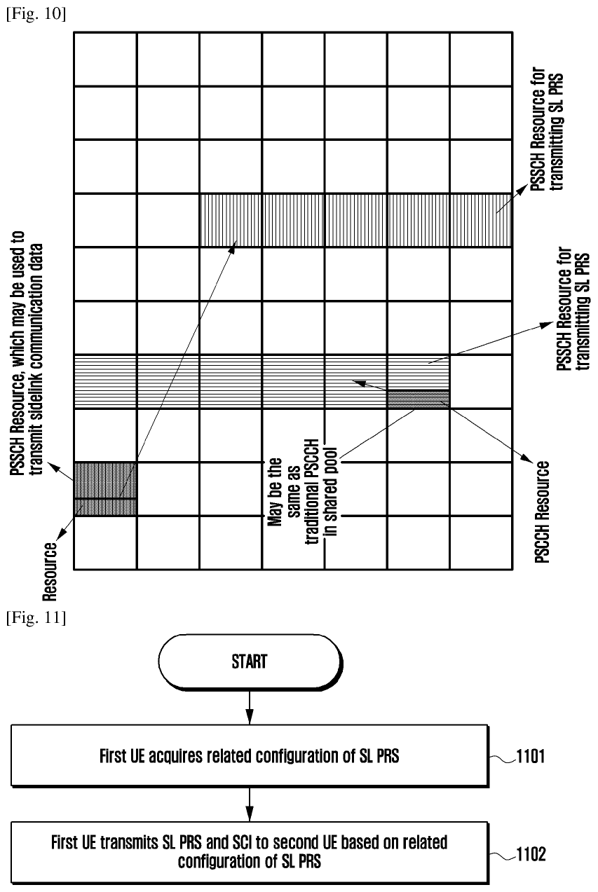

FIG. 11 illustrates an exemplary method according to an embodiment of the disclosure.

In step 1101, a first UE acquires a configuration related to a Sidelink Positioning Reference Signal (SL PRS). In various embodiments, a configuration of resources the SL PRS and/or a configuration of a resource pool where the SL PRS is located may be acquired from a base station, may be configured by an upper layer, or may be pre-configured in the first UE.

In step 1102, the first UE transmits the SL PRS and Sidelink Control Information (SCI) associated with the SL PRS to a second node UE based on the configuration related to the SL PRS.

The second UE acquires the configuration related to the Sidelink Positioning Reference Signal (SL PRS), and receives the SL PRS and the Sidelink Control Information (SCI) associated with the SL PRS from the first UE based on the configuration related to the SL PRS; comprising receiving the SCI, and receiving the SL PRS from the first UE according to information indicated in the received SCI and/or correspondence between SL PRS resources and PSCCH resources. The second UE may measure the SL PRS, and the measurement results may be reported by the second UE to the network side and/or the base station and/or fed back to the first UE for determining position information of the first UE.

In a further embodiment, a resource used to transmit the SL PRS in the first UE is determined based on the configuration related to the SL PRS, and/or the correspondence between the SL PRS resources and the PSCCH resources, and the determined PSCCH resource; and/or wherein PSCCH resources used to transmit the SCI are determined based on a related configuration of a PSCCH associated with the SL PRS, and/or the correspondence between the SL PRS resources and the PSCCH resources, and the determined resource used to transmit the SL PRS.

In various embodiments, the first UE determines whether SL PRSs using different SL PRS resources can be multiplexed on the same time-domain and/or frequency-domain resource based on the configuration; and/or the first UE determines SL PRSs of the SL PRSs using the different SL PRS resources, which can be multiplexed on the same time-domain and/or frequency-domain resource, based on the configuration.

In various embodiments, the first UE determines that two or more SL PRSs using different SL PRS resources are multiplexed on the same time-domain and/or frequency-domain resource when at least one of the following conditions is met: starting positions of time-domain and/or frequency-domain resources of the two or more SL PRSs are the same, ending positions of the time-domain and/or frequency-domain resources of the two or more SL PRSs are the same, sizes of the time-domain and/or frequency-domain resources of the two or more SL PRSs are the same, the time-domain and/or frequency-domain resources of the two or more SL PRSs are the same, the time-domain and/or frequency-domain resources of the two or more SL PRSs are in a same slot, the frequency-domain resources of the two or more SL PRSs are in a same Resource Block (RB), the frequency-domain resources of the two or more SL PRSs are in a same subchannel, and the frequency-domain resources of the two or more SL PRSs are in a same subchannel group.

In various embodiments, the configuration related to the SL PRS comprises a related configuration of a subchannel group used to transmit the SL PRS and/or a related configuration of Physical Sidelink Control Channels (PSCCHs) associated with the SL PRS.

In various embodiments, the related configuration of the subchannel group used to transmit the SL PRS comprises at least one of the following: information as to whether to enable the subchannel group; a size of the subchannel group; indexes of subchannels included in the subchannel group; and a frequency-domain resource position of at least one subchannel group.

In various embodiments, the related configuration of the PSCCH associated with the SL PRS comprises at least one of the following: positions of PSCCH resources included in a subchannel; positions of PSCCH resources included in a subchannel group; a number of PSCCH occasions included in the subchannel; a number of PSCCH occasions included in the subchannel group; a time-domain resource size and/or frequency-domain resource size of one or each of PSCCH occasions; a time-domain resource position and/or frequency-domain resource position of a starting PSCCH occasion included in the subchannel; a time-domain resource position and/or frequency-domain resource position of a starting PSCCH occasion included in the subchannel group; and an offset between two adjacent or any two PSCCH occasions, wherein, the PSCCH occasions comprise a resource unit used to transmit at least one PSCCH.

In various embodiments, the number of PSCCH occasion(s) included in the subchannel is one or more, and when the subchannel comprises a plurality of PSCCH occasions, the plurality of PSCCH occasions correspond to transmission of SCI associated with a plurality of SL PRSs multiplexed on the subchannel; and/or the number of PSCCH occasion(s) included in the subchannel group is one or more, and when the subchannel group comprises a plurality of PSCCH occasions, the plurality of PSCCH occasions correspond to transmission of SCI associated with a plurality of SL PRSs multiplexed on the subchannel group.

In various embodiments, when a subchannel comprises one or more PSCCH occasions, a time-domain and/or frequency-domain resource occupied by a PSCCH occasion with the lowest Physical Resource Block (PRB) index is the same as a time-domain and/or frequency-domain resource of a PSCCH in the sidelink communication system; and/or when at least one subchannel in the subchannel group comprises a PSCCH occasion, a time-frequency-domain resource occupied by the PSCCH occasion is the same as a PSCCH resource in the sidelink communication system.

In various embodiments, when the subchannel comprises one or more PSCCH occasions and a resource pool for PSCCHs and SL PRSs is configured to be shared with sidelink communication, a time-domain and/or frequency-domain resource occupied by a PSCCH occasion with the lowest index of Physical Resource Block (PRB) is the same as a time-domain and/or frequency-domain resource of a PSCCH in the sidelink communication system; and/or when at least one subchannel in the subchannel group comprises a PSCCH occasion and a resource pool for PSCCHs and SL PRSs is configured to be shared with sidelink communication, a time-frequency-domain resource occupied by the PSCCH occasion is the same as a PSCCH resource in the sidelink communication system.

In various embodiments, when the first UE transmits an SL PRS in at least one subchannel group, and a resource pool for PSCCHs and SL PRSs is configured to be shared with sidelink communication, a time-domain and/or frequency-domain resource used by the SL PRS is indicated in SCI based on subchannels; and/or when the first UE transmits an SL PRS in at least one subchannel group, and a resource pool for PSCCHs and SL PRSs is configured to be dedicated to SL PRSs, a time-domain and/or frequency-domain resource used by the SL PRS is indicated in SCI based on subchannels or the subchannel group.

In various embodiments, a preset correspondence between SL PRS resources and PSCCH resources comprises a correspondence between resources used to transmit the SL PRS and PSCCH occasions; and/or the correspondence between the SL PRS resources and the PSCCH resources comprises a correspondence between a set of SL PRS resources and PSCCH occasions.

In various embodiments, the correspondence between the set of SL PRS resources and the PSCCH occasions comprises a mapping relationship between indexes of the SL PRS resources and indexes of the PSCCH occasions, and the method for indexing the PSCCH occasions comprises at least one of the following: obtaining the indexes of the PSCCH occasions by ordering the PSCCH occasions in ascending order in the frequency domain in the subchannels; in the subchannel group, the subchannels are first ordered in the frequency domain in ascending order, and obtaining the indexes of the PSCCH occasions by ordering the PSCCH occasions in a manner of ascending order in the frequency domain in the subchannel group first and then ascending order of PRBs in the subchannels.

In various embodiments, the related configuration of the PSCCH associated with the SL PRS comprises at least one of the following: a PSCCH period, which indicates a number of time units corresponding to a period of PSCCH resources in the resource pool; all PSCCH frequency-domain resources in the resource pool; a frequency-domain resource of a PSCCH resource; and an index of a PSCCH resource.

In various embodiments, the correspondence between the SL PRS resources and the PSCCH resources comprises: when the first UE transmits the SL PRS in slot n, a PSCCH associated with the SL PRS being transmitted in a latest slot containing a PSCCH resource no later than slot n-k.

In various embodiments, the correspondence between the SL PRS resources and the PSCCH resources comprises: for SL PRS resources within a PSCCH period, PSCCH resources being allocated to each of the SL PRS resources sequentially in ascending order of PSCCH resources indexes, in a manner of ascending order in time domain first and then ascending order in frequency domain and then ascending order of SL PRS resource indexes, or in a manner of ascending order in frequency domain first and then ascending order in time domain and then ascending order of SL PRS resource indexes.

In various embodiments, if SL PRS resources selected by the first UE comprise a plurality of subchannels, the first UE acquires a corresponding PSCCH resource according to a subchannel with the lowest index of the plurality of subchannels according to a correspondence between the resources; and/or maps and acquires the corresponding PSCCH resource according to all of the subchannels according to the correspondence between the resources.

In various embodiments, when the first UE acquires a plurality of PSCCH resources for transmitting SCI, the first UE transmits SCI corresponding to the SL PRS to the second UE on the plurality of PSCCH resources or transmits the SCI corresponding to the SL PRS to the second UE on a subset of the plurality of PSCCH resources.

In various embodiments, when there are PSCCH resources and Physical Sidelink Shared Channel (PSSCH) resources in the resource pool, the PSCCH resource corresponding to the PSCCH resource used by the first UE to transmit the SCI is used for at least one of the following: transmitting the SL PRS; transmitting the PSSCH; and not being used for transmitting the SL PRS or the PSSCH.

In various embodiments, the method for the first UE to transmit the PSSCH and the SL PRS to the second UE and indicate the control information of the SL PRS and/or the control information of the PSSCH in the PSCCH resource comprises at least one of the following: transmitting a SCI format associated with the SL PRS and a SCI format associated with the PSSCH on the PSCCH resource; transmitting the SCI format associated with the SL PRS on the PSCCH resource, and further indicating a resource used by the PSSCH in the SCI format; transmitting the SCI format associated with the PSSCH on the PSCCH resource, and further indicating a resource used by the SL PRS in the SCI format; transmitting the SCI format associated with the SL PRS on the PSCCH resource, and transmitting the SCI format associated with the PSSCH on the PSSCH resource corresponding to the PSCCH resource; and transmitting the SCI format associated with the PSSCH on the PSCCH resource, and transmitting the SCI format associated with the SL PRS on the PSSCH resource corresponding to the PSCCH resource.

According to one aspect of the present disclosure, there is provided a method performed by a second UE in a wireless communication system, the comprising: receiving by a second UE a Sidelink Positioning Reference Signal (SL PRS) and Sidelink Control Information (SCI) associated with the SL PRS from a first UE; and performing measurement by the second UE based on the received SL PRS and the Sidelink Control Information (SCI) associated with the SL PRS.

In a further embodiment, the second UE receives the SCI and the SL PRS on the resource on which the first UE transmitted the SCI and the SL PRS as described above.

In various embodiments, the second UE receives the SCI corresponding to the SL PRS from the first UE on the plurality of PSCCH resources or receives the SCI corresponding to the SL PRS on a subset of the plurality of PSCCH resources.

In various embodiments, when there are PSCCH resources and Physical Sidelink Shared Channel PSSCH resources in the resource pool, the PSCCH resource corresponding to the PSCCH resource used by the second UE to receive the SCI is used for at least one of the following: receiving the SL PRS; receiving the PSSCH; and not being used for receiving the SL PRS or the PSSCH.

In various embodiments, the method for the second UE to receive the PSSCH and the SL PRS from the first UE and receive the control information of the SL PRS and/or the control information of the PSSCH in the PSCCH resource comprises at least one of the following: receiving a SCI format associated with the SL PRS and a SCI format associated with the PSSCH on the PSCCH resource; receiving the SCI format associated with the SL PRS on the PSCCH resource, and further indicating a resource used by the PSSCH in the SCI format; receiving the SCI format associated with the PSSCH on the PSCCH resource, and further indicating a resource used by the SL PRS in the SCI format; receiving the SCI format associated with the SL PRS on the PSCCH resource, and receiving the SCI format associated with the PSSCH on the PSSCH resource corresponding to the PSCCH resource; and receiving the SCI format associated with the PSSCH on the PSCCH resource, and receiving the SCI format associated with the SL PRS on the PSSCH resource corresponding to the PSCCH resource.

According to one aspect of the present disclosure, there is provided a user equipment (UE) in a wireless communication system, comprising: a transceiver configured to transmit and receive a signal; and a processor coupled to the transceiver and configured to control the transceiver to perform the method as described above.

Those skilled in the art will understand that the above-described illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily appreciated that the various aspects of the disclosed invention, as generally described herein and illustrated in the accompanying drawings, may be arranged, substituted, combined, separated, and designed in various different configurations, all of which are herein was envisaged.

Those of skill in the art will understand that the various illustrative logic blocks, modules, circuits, and steps described herein can be implemented as hardware, software, or combinations of both. To clearly illustrate this interchangeability of hardware and software, various illustrative components, blocks, modules, circuits, and steps have been described above generally in terms of their function sets. Whether such a feature set is implemented as hardware or software depends on the specific application and design constraints imposed on the overall system. Those skilled in the art may implement the described function sets in varying ways for each particular application, but such design decisions should not be interpreted as causing a departure from the scope of this application.

The various illustrative logic blocks, modules, and circuits described in this application may be implemented or performed in general-purpose processors, digital signal processors (DSPs), application specific integrated circuits (ASICs), field programmable gate arrays (FPGAs) or other programmable logic devices, discrete gates or transistor logics, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, multiple microprocessors, one or more microprocessors cooperating with a DSP core, or any other such configuration.

The steps of a method or algorithm described herein may be embodied directly in hardware, in a software module executed by a processor, or in a combination of the two. A software module may reside in RAM memory, flash memory, ROM memory, EPROM memory, EEPROM memory, registers, hard disk, removable disk, or any other form of storage medium known in the art. An exemplary storage medium is coupled to the processor such the processor can read information from, and write information to, the storage medium. In the alternative, the storage medium may be integrated into the processor. The processor and storage medium may reside in the ASIC. The ASIC may reside in the user equipment. In the alternative, the processor and storage medium may reside in the user equipment as discrete components.

In one or more exemplary designs, the functions may be implemented in hardware, software, firmware, or any combination thereof. If implemented in software, the functions may be stored on or transmitted over as one or more instructions or code in a computer-readable medium. Computer-readable media comprises both computer storage media and communication media including any medium that facilitates transfer of a computer program from one place to another. A storage medium can be any available medium that can be accessed by a general purpose or special purpose computer.

The above description is only exemplary embodiments of the present invention and is not intended to limit the scope of the present invention, which is defined by the appended claims.

1-15. (canceled)

16. A method performed by a user equipment (UE) in a communication system, the method comprising:
receiving a configuration associated with a sidelink (SL) positioning reference signal (PRS);
determining SL PRS resources associated with SL control information (SCI) based on the configuration;
transmitting the SCI via a physical SL control channel (PSCCH); and
performing an SL PRS transmission based on the SL PRS resources,
wherein an index for a resource for the PSCCH is determined based on an index for an SL PRS resource among the SL PRS resources.

17. The method of claim 16, wherein the index for the resource for the PSCCH is determined to be identical to the index for the SL PRS resource,
wherein the resource for the PSCCH corresponds to a subchannel for the PSCCH, and
wherein the index for the SL PRS resource is configured based on the configuration.

18. The method of claim 16, wherein the configuration includes information on a time-domain size for the PSCCH and information on a frequency-domain size for the PSCCH, and
wherein the information on the frequency-domain size for the PSCCH indicates a number of physical resource blocks (PRBs) for the PSCCH.

19. The method of claim 16, wherein the configuration includes a resource pool configuration for an SL PRS dedicated resource pool.

20. The method of claim 19, wherein in case that the resource pool configuration is for a shared SL PRS resource pool, the SL PRS resources correspond to physical sidelink shared channel (PSSCH) resources included in the shared SL PRS resource pool,
wherein symbols for a second-stage SCI are not used for the SL PRS resources included the shared SL PRS resource pool, and
wherein a number of the symbols for the second-stage SCI is indicated in the resource pool configuration.

21. A user equipment (UE) in a communication system, the UE comprising:
a transceiver; and
a processor coupled with the transceiver and configured to:
receive a configuration associated with a sidelink (SL) positioning reference signal (PRS),
determine SL PRS resources associated with SL control information (SCI) based on the configuration,
transmit the SCI via a physical SL control channel (PSCCH), and
perform an SL PRS transmission based on the SL PRS resources,
wherein an index for a resource for the PSCCH is determined based on an index for an SL PRS resource among the SL PRS resources.

22. The UE of claim 21, wherein the index for the resource for the PSCCH is determined to be identical to the index for the SL PRS resource,
wherein the resource for the PSCCH corresponds to a subchannel for the PSCCH, and
wherein the index for the SL PRS resource is configured based on the configuration.

23. The UE of claim 21, wherein the configuration includes information on a time-domain size for the PSCCH and information on a frequency-domain size for the PSCCH, and
wherein the information on the frequency-domain size for the PSCCH indicates a number of physical resource blocks (PRBs) for the PSCCH.

24. The UE of claim 21, wherein the configuration includes a resource pool configuration for an SL PRS dedicated resource pool.

25. The UE of claim 24, wherein in case that the resource pool configuration is for a shared SL PRS resource pool, the SL PRS resources correspond to physical SL shared channel (PSSCH) resources included in the shared SL PRS resource pool,
wherein symbols for a second-stage SCI are not used for the SL PRS resources included the shared SL PRS resource pool, and
wherein a number of the symbols for the second-stage SCI is indicated in the resource pool configuration.

26. A method performed by a user equipment (UE) in a communication system, the method comprising:
receiving a configuration associated with a sidelink (SL) positioning reference signal (PRS);
receiving, based on the configuration, SL control information (SCI) via a physical SL control channel (PSCCH); and
receiving, based on the configuration, an SL PRS transmission on SL PRS resources associated with the SL control information SCI,
wherein an index for a resource for the PSCCH is determined based on an index for an SL PRS resource among the SL PRS resources.

27. The method of claim 26, wherein the index for the resource for the PSCCH is determined to be identical to the index for the SL PRS resource,
wherein the resource for the PSCCH corresponds to a subchannel for the PSCCH, and
wherein the index for the SL PRS resource is configured based on the configuration.

28. The method of claim 26, wherein the configuration includes information on a time-domain size for the PSCCH and information on a frequency-domain size for the PSCCH, and
wherein the information on the frequency-domain size for the PSCCH indicates a number of physical resource blocks (PRBs) for the PSCCH.

29. The method of claim 26, wherein the configuration includes a resource pool configuration for an AL PRS dedicated resource pool.

30. The method of claim 29, wherein in case that the resource pool configuration is for a shared SL PRS resource pool, the SL PRS resources correspond to physical SL shared channel (PSSCH) resources included in the shared SL PRS resource pool,
wherein symbols for a second-stage SCI are not used for the SL PRS resources included the shared SL PRS resource pool, and
wherein a number of the symbols for the second-stage SCI is indicated in the resource pool configuration.

31. A user equipment (UE) in a communication system, the UE comprising:
a transceiver; and
a processor coupled with the transceiver and configured to:
receive a configuration associated with a sidelink (SL) positioning reference signal (PRS),
receive, based on the configuration, SL control information (SCI) via a physical SL control channel (PSCCH), and
receive, based on the configuration, an SL PRS transmission on SL PRS resources associated with the SL control information SCI,
wherein an index for a resource for the PSCCH is determined based on an index for an SL PRS resource among the SL PRS resources.

32. The UE of claim 31, wherein the index for the resource for the PSCCH is determined to be identical to the index for the SL PRS resource,
wherein the resource for the PSCCH corresponds to a subchannel for the PSCCH, and
wherein the index for the SL PRS resource is configured based on the configuration.

33. The UE of claim 31, wherein the configuration includes information on a time-domain size for the PSCCH and information on a frequency-domain size for the PSCCH, and
wherein the information on the frequency-domain size for the PSCCH indicates a number of physical resource blocks (PRBs) for the PSCCH.

34. The UE of claim 31, wherein the configuration includes a resource pool configuration for an SL PRS dedicated resource pool.

35. The UE of claim 34, wherein in case that the resource pool configuration is for a shared SL PRS resource pool, the SL PRS resources corresponded to physical SL shared channel (PSSCH) resources included in the shared SL PRS resource pool,
wherein symbols for a second-stage SCI are not used for the SL PRS resources included the shared SL PRS resource pool, and
wherein a number of the symbols for the second-stage SCI is indicated in the resource pool configuration.
